(19) United States
(12) Patent Application Publication
(10) Pub. No.: US 2025/0211789 A1
(43) Pub. Date: Jun. 26, 2025

(54) METHODS AND APPARATUS FOR TRANSFORM TRAINING AND CODING

(71) Applicant: BEIJING DAJIA INTERNET INFORMATION TECHNOLOGY CO., LTD., Beijing (CN)

(72) Inventors: Ning YAN, San Diego, CA (US); Xiaoyu XIU, San Diego, CA (US); Wei CHEN, San Diego, CA (US); Hong-Jheng JHU, San Diego, CA (US); Che-Wei KUO, San Diego, CA (US); Changyue MA, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/065,843

(22) Filed: Feb. 27, 2025

Related U.S. Application Data
(63) Continuation of application No. PCT/US2023/031305, filed on Aug. 28, 2023.
(63) Continuation of application No. PCT/US2023/036725, filed on Nov. 2, 2023.
(63) Continuation of application No. PCT/US2024/011479, filed on Jan. 12, 2024.
(60) Provisional application No. 63/401,711, filed on Aug. 28, 2022.
(60) Provisional application No. 63/421,990, filed on Nov. 2, 2022.
(60) Provisional application No. 63/439,039, filed on Jan. 13, 2023.

(51) Int. Cl. H04N 19/60; H04N 19/172; H04N 19/174; H04N 19/70

(52) U.S. Cl. CPC H04N 19/60; H04N 19/172; H04N 19/174; H04N 19/70

(57) ABSTRACT

The disclosure generally includes a device and methods for video decoding and encoding. The methods include deriving, a karhunen-loève transform (KLT) matrix from a video sequence, each picture in the video sequence, or each slice in the video sequence, generating an adaptive KLT matrix signal, and signaling the adaptive KLT matrix signal in a sequence parameter set (SPS) header, a picture parameter set (PPS) header, and/or slice header.

### CROSS-REFERENCE TO RELATED APPLICATION

The present application claims is based upon and claims priorities to International Application No. PCT/US2023/031305, filed on Aug. 28, 2023, which claims priority to U.S. Provisional Application No. 63/401,711, filed on Aug. 28, 2022, and to International Application No. PCT/US2023/036725, filed on Nov. 2, 2023, which claims priority to U.S. Provisional Application No. 63/421,990, filed on Nov. 2, 2022, and to International Application No. PCT/US2024/011479, filed on Jan. 12, 2024, which claims priority to U.S. Provisional Application No. 63/439,039, filed on Jan. 13, 2023, the entireties of which are incorporated by reference for all purposes.

### FIELD

The present disclosure is related to video coding and compression, and in particular but not limited to, methods and apparatus on improving the coding efficiency of transform coding.

### BACKGROUND

Various video coding techniques may be used to compress video data. Video coding is performed according to one or more video coding standards. For example, nowadays, some well-known video coding standards include Versatile Video Coding (VVC), High Efficiency Video Coding (HEVC, also known as H.265 or MPEG-H Part2) and Advanced Video Coding (AVC, also known as H.264 or MPEG-4 Part 10), which are jointly developed by ISO/IEC MPEG and ITU-T VECG. AOMedia Video 1 (AV1) was developed by Alliance for Open Media (AOM) as a successor to its preceding standard VP9. Audio Video Coding (AVS), which refers to digital audio and digital video compression standard, is another video compression standard series developed by the Audio and Video Coding Standard Workgroup of China. Most of the existing video coding standards are built upon the famous hybrid video coding framework i.e., using block-based prediction methods (e.g., inter-prediction, intra-prediction) to reduce redundancy present in video images or sequences and using transform coding to compact the energy of the prediction errors. An important goal of video coding techniques is to compress video data into a form that uses a lower bit rate while avoiding or minimizing degradations to video quality. However, the existing transform coding methods do not have good coding efficiency.

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

The present disclosure provides embodiments of techniques relating to improving the coding efficiency of transform coding.

In a first aspect, the present disclosure provides a method for video encoding comprising deriving, by an encoder, a karhunen-loève transform (KLT) matrix from a video sequence, generating, by the encoder, an adaptive KLT matrix signal for the KLT matrix, and signaling, by the encoder, the adaptive KLT matrix signal in a sequence parameter set (SPS) header.

In a second aspect, the present disclosure provides a method for video encoding comprising deriving, by the encoder, a KLT matrix from each picture in the video sequence, generating, by the encoder, the adaptive KLT matrix signal for the KLT matrix, and signaling, by the encoder, the adaptive KLT matrix signal in a picture parameter set (PPS).

In a third aspect, the present disclosure provides a method for video encoding comprising deriving, by the encoder, the KLT matrix from each slice in a video sequence, generating, by the encoder, the adaptive KLT matrix signal for the KLT matrix, and signaling by the encoder, the adaptive KLT matrix signal in a slice header.

In a fourth aspect, the present disclosure provides a method for video decoding comprising receiving the adaptive KLT matrix signal in the SPS header, wherein the adaptive KLT matrix signal is derived from the video sequence, and obtaining the KLT matrix based on the adaptive KLT matrix signal.

In a fifth aspect, the present disclosure provides a method for video decoding comprising receiving an adaptive KLT matrix signal in the PPS header, wherein the adaptive KLT matrix signal is derived from a picture in the video sequence, and obtaining the KLT matrix based on the adaptive KLT matrix signal.

In a sixth aspect, the present disclosure provides a method for video decoding comprising receiving the adaptive KLT matrix signal in the slice header, wherein the adaptive KLT matrix is derived from the slice in the video sequence, and obtaining the KLT matrix based on the adaptive KLT matrix signal.

In a seventh aspect, the present disclosure provides a method for video encoding comprising: determining, by an encoder, a low-frequency non-separable transform (LFNST) for a video sequence; determining, by the encoder, that multiple transform selection (MTS) is enabled for one or more transform blocks; determining, by the encoder, that the LFNST is enabled for the one or more transform blocks coded with MTS; and applying, by the encoder, the LFNST to the one or more transform blocks.

In an eighth aspect, the present disclosure provides a method for video decoding, comprising: determining, by a decoder, a low-frequency non-separable transform (LFNST) for a video sequence; determining, by the decoder, that multiple transform selection (MTS) is enabled for transform blocks; determining, by the decoder, that the LFNST is enabled for the one or more transform blocks coded with MTS; and applying, by the decoder, the LFNST to the one or more transform blocks.

In a ninth aspect, some embodiments of the present disclosure provide a method for video decoding including: obtaining, by a decoder, a plurality of Karhunen-Loève Transform (KLT) transform kernels for a current block in an intra mode; and selecting, by the decoder, a KLT transform kernel for the current block in the intra mode from the plurality of KLT transform kernels.

In a tenth aspect, some embodiments of the present disclosure provide a method for video encoding, including: obtaining, by an encoder, a plurality of Karhunen-Loève Transform (KLT) transform kernels for a current block in an intra mode; determining, by the encoder, that KLT is enabled for the current block; and selecting, by the encoder, a KLT transform kernel for the current block in the intra mode from the plurality of KLT transform kernels.

In an eleven aspect, some embodiments of the present disclosure provide an apparatus for video decoding. The apparatus includes one or more processors; and a memory coupled to the one or more processors and configured to store instructions executable by the one or more processors, wherein the one or more processors, upon execution of the instructions are configured to perform the method according to the fourth aspect, the fifth aspect, the sixth aspect, the eighth aspect or ninth aspect.

In a twelfth aspect, some embodiments of the present disclosure provide an apparatus for video encoding. The apparatus includes one or more processors; and a memory coupled to the one or more processors and configured to store instructions executable by the one or more processors, wherein the one or more processors, upon execution of the instructions are configured to perform the method according to the first aspect, the second aspect, the third aspect, the seventh aspect or tenth aspect.

In a thirteenth aspect, some embodiments of the present disclosure provide a non-transitory computer readable storage medium for storing computer-executable instructions that, when executed by one or more computer processors, cause the one or more computer processors to perform the method according to the fourth aspect, the fifth aspect, the sixth aspect, the eighth aspect or ninth aspect.

In a fourteenth aspect, some embodiments of the present disclosure provide a non-transitory computer readable storage medium for storing computer-executable instructions that, when executed by one or more computer processors, cause the one or more computer processors to perform the method according to the first aspect, the second aspect, the third aspect, the seventh aspect or tenth aspect.

In a fifteenth aspect, some embodiments of the present disclosure provide a non-transitory computer-readable storage medium for storing a bitstream to be decoded by the method according to the fourth aspect, the fifth aspect, the sixth aspect, the eighth aspect or ninth aspect.

In a sixteenth aspect, some embodiments of the present disclosure provide a non-transitory computer-readable storage medium for storing a bitstream generated by the method according to the first aspect, the second aspect, the third aspect, the seventh aspect or tenth aspect.

It is to be understood that both the foregoing general description and the following detailed description are embodiments only and are not restrictive of the present disclosure.

### BRIEF DESCRIPTION OF THE DRAWINGS

A more particular description of the embodiments of the present disclosure will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings.

FIG. 1 is a block diagram illustrating a system for encoding and decoding video blocks in accordance with some embodiments of the present disclosure.

FIG. 2A is a block diagram of an encoder in accordance with some embodiments of the present disclosure.

FIG. 2B is a block diagram illustrating an exemplary video encoder in accordance with some embodiments of the present disclosure.

FIGS. 2C-2G are block diagrams illustrating how a frame is recursively partitioned into multiple video blocks of different sizes and shapes in accordance with some embodiments of the present disclosure.

FIG. 3A is a block diagram of a decoder in accordance with some embodiments of the present disclosure.

FIG. 3B is a block diagram illustrating an exemplary video decoder in accordance with some embodiments of the present disclosure.

FIGS. 3C-3K are block diagrams illustrating how a frame is recursively partitioned into multiple video blocks of different sizes and shapes in accordance with some embodiments of the present disclosure. Particularly, FIG. 3C illustrates generating an encoded representation of a frame; FIG. 3D illustrates composition of a CTU, FIG. 3E illustrates division of CTUs, FIG. 3F depicts a quad-tree data structure illustrating the end result of the partition process of the CTU as depicted in FIG. 3E, and FIGS. 3G-3K illustrate five possible partitioning types of a coding block.

FIG. 4 shows an example of Low-Frequency Non-Separable Transform (LFNST) process in accordance with some embodiments of the present disclosure.

FIGS. 5A-5D show embodiments of Subblock Transform (SBT) types and SBT positions in accordance with some embodiments of the present disclosure.

FIG. 6 shows an example of the Region-Of-Interest (ROI) for LFNST16 in accordance with some embodiments of the present disclosure.

FIG. 7 shows an example of the ROI for LFNST8 in accordance with some embodiments of the present disclosure.

FIG. 8 is a flowchart of Karhunen-Loeve Transform (KLT) exploring the non-local correlations in accordance with some embodiments of the present disclosure.

FIG. 9 shows an illustration of the template used for transform block clustering in accordance with some embodiments of the present disclosure.

FIG. 10 shows an illustration of training data clustering based on prediction mode and neighboring template.

FIG. 11 is a flowchart illustrating a method for video encoding in accordance with some embodiments of the present disclosure.

FIG. 12 is a flowchart illustrating a method for video encoding in accordance with some embodiments of the present disclosure.

FIG. 13 is a flowchart illustrating a method for video encoding in accordance with some embodiments of the present disclosure.

FIG. 14 is a flowchart illustrating a method for video decoding in accordance with some embodiments of the present disclosure.

FIG. 15 is a flowchart illustrating a method for video decoding in accordance with some embodiments of the present disclosure.

FIG. 16 is a flowchart illustrating a method for video decoding in accordance with some embodiments of the present disclosure.

FIG. 17 is a flowchart illustrating a method for video encoding in accordance with some embodiments of the present disclosure.

FIG. 18 is a flowchart illustrating a method for video encoding in accordance with some embodiments of the present disclosure.

FIG. 19 is a flowchart illustrating a method for video decoding in accordance with some embodiments of the present disclosure.

FIG. 20 is a flowchart illustrating a method for video encoding corresponding to the method for video decoding illustrated in FIG. 15 and in accordance with some embodiments of the present disclosure.

FIG. 21 is an illustration of angular intra prediction modes in VVC and ECM in accordance with some embodiments of the present disclosure.

FIG. 22A is an illustration of an example that the transform coefficients in the left-above area are retained in accordance with some embodiments of the present disclosure.

FIG. 22B is an illustration of an example that the transform coefficients in the above area are retained in accordance with some embodiments of the present disclosure.

FIG. 22C is an illustration of an example that the transform coefficients in the left area are retained in accordance with some embodiments of the present disclosure.

FIG. 22D is an illustration of an example that the transform coefficients in the left and above areas are retained, where the left and above areas include both the above area and the left area in accordance with some embodiments of the present disclosure.

FIG. 23 is an illustration of block transpose and intra mode mapping for KLT matrix sharing in accordance with some embodiments of the present disclosure.

FIG. 24 is a diagram illustrating a computing environment coupled with a user interface in accordance with some embodiments of the present disclosure.

### DETAILED DESCRIPTION

Reference will now be made in detail to specific implementations, embodiments of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may include any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of moving the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may include camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

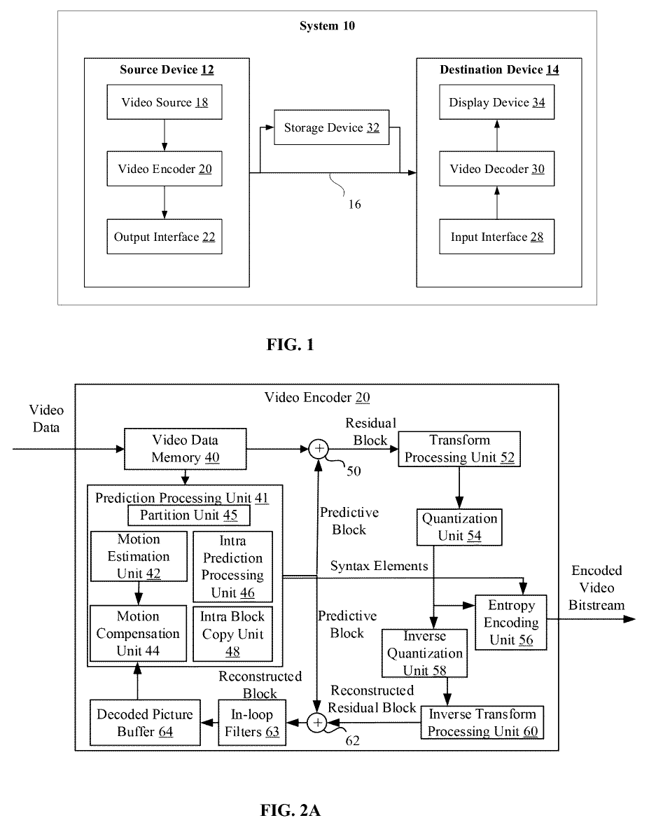

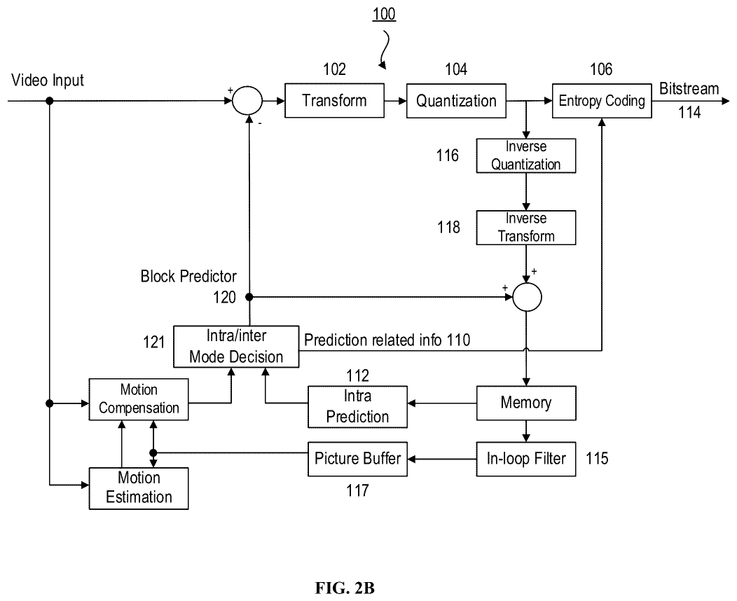

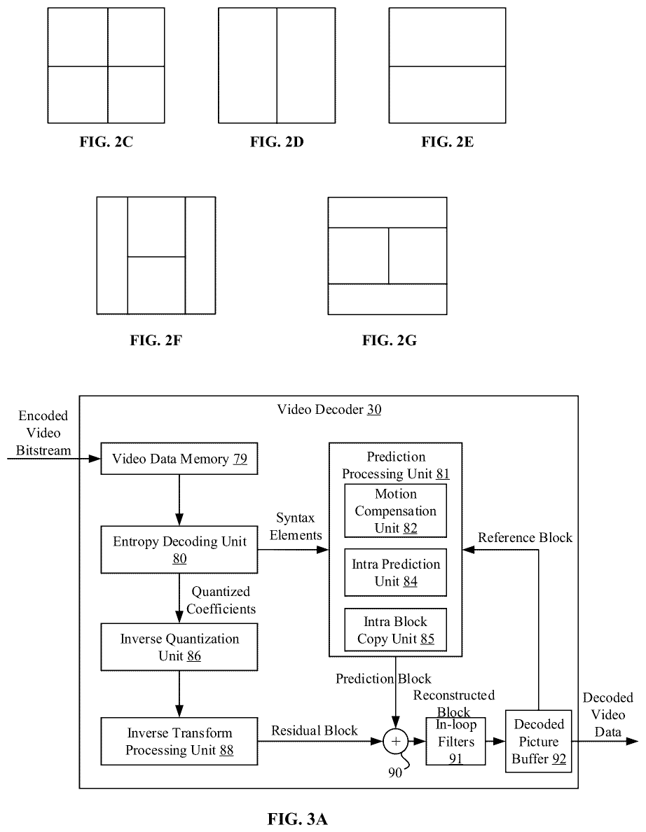

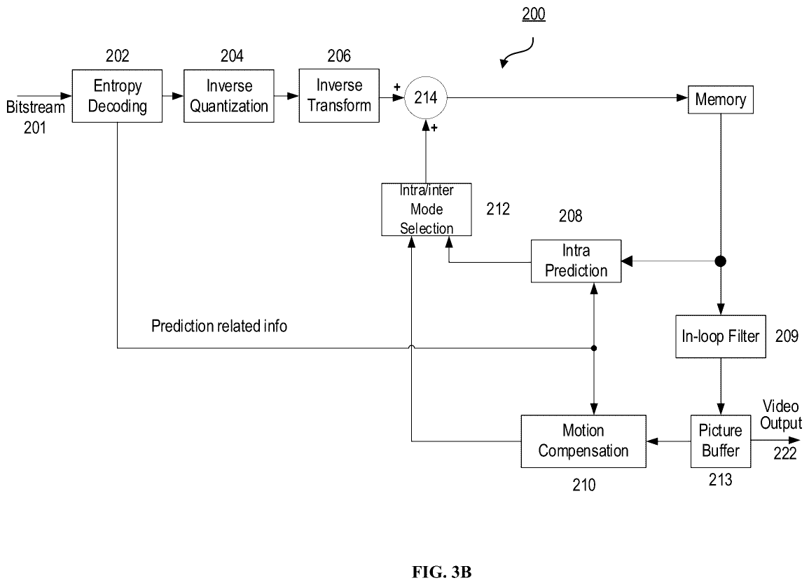

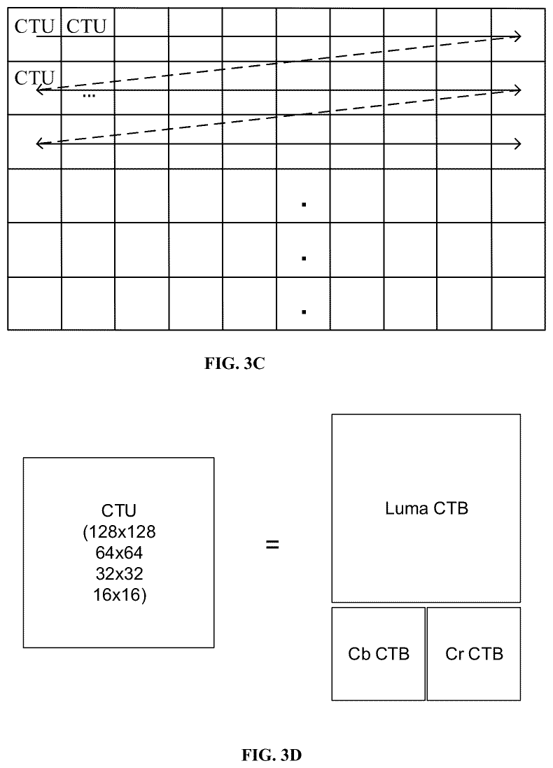

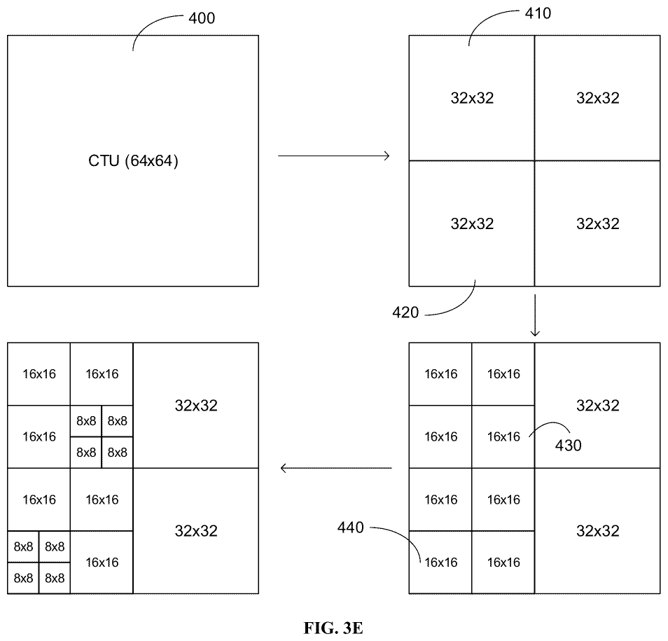

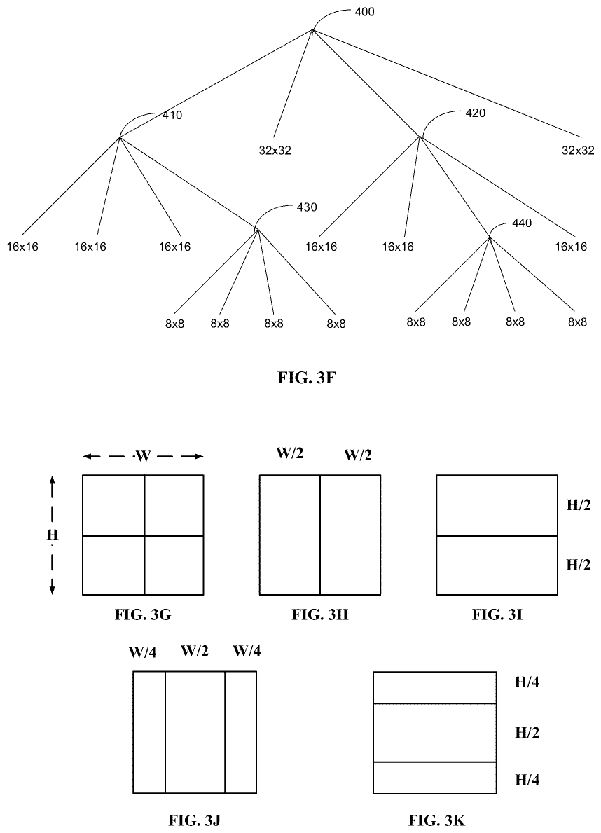

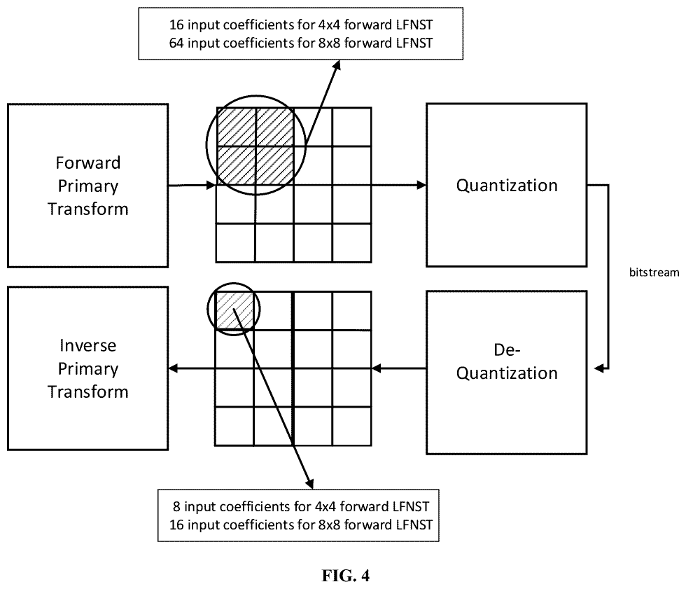

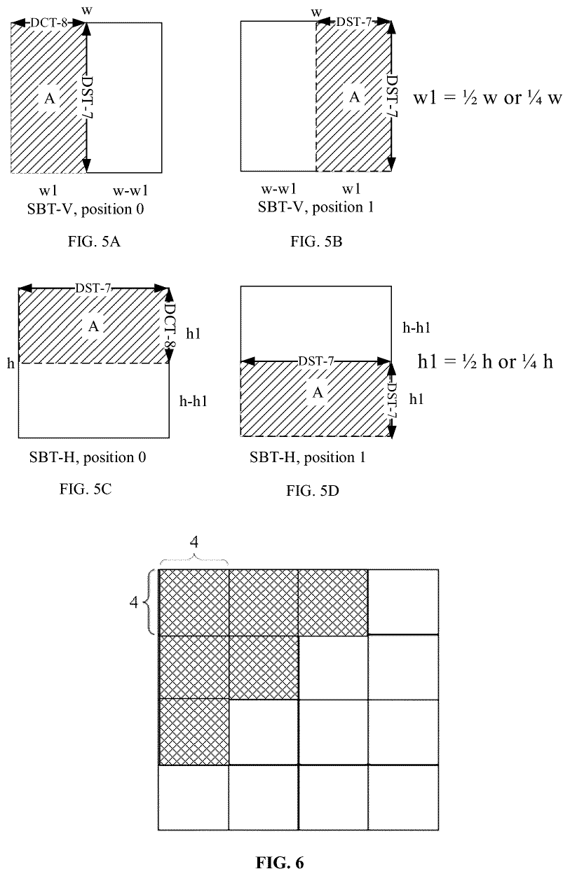

In some implementations, at least a part of components of the source device 12 (for example, the video source 18, the video encoder 20 or components included in the video encoder 20 as described below with reference to FIG. 2A, and the output interface 22) and/or at least a part of components of the destination device 14 (for example, the input interface 28, the video decoder 30 or components included in the video decoder 30 as described below with reference to FIG. 3A, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2A is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2A, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some embodiments, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various embodiments, the video data memory 40 may be on-chip with other components of the video encoder 20, or off-chip relative to those components.

As shown in FIG. 2A, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma difference components or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some embodiments, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other embodiments, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some embodiments) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via cither inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some embodiments, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

The first generation AVS standard includes Chinese national standard “Information Technology, Advanced Audio Video Coding, Part 2: Video” (known as AVS1) and “Information Technology, Advanced Audio Video Coding Part 16: Radio Television Video” (known as AVS+). It can offer around 50% bit-rate saving at the same perceptual quality compared to MPEG-2 standard. The AVS1 standard video part was promulgated as the Chinese national standard in February 2006. The second generation AVS standard includes the series of Chinese national standard “Information Technology, Efficient Multimedia Coding” (knows as AVS2), which is mainly targeted at the transmission of extra HD TV programs. The coding efficiency of the AVS2 is double of that of the AVS+. In May 2016, the AVS2 was issued as the Chinese national standard. Meanwhile, the AVS2 standard video part was submitted by Institute of Electrical and Electronics Engineers (IEEE) as one international standard for applications. The AVS3 standard is one new generation video coding standard for UHD video application aiming at surpassing the coding efficiency of the latest international standard HEVC. In March 2019, at the 68-th AVS meeting, the AVS3-P2 baseline was finished, which provides approximately 30% bit-rate savings over the HEVC standard. Currently, there is one reference software, called high performance model (HPM), is maintained by the AVS group to demonstrate a reference implementation of the AVS3 standard.

Like the HEVC, the AVS3 standard is built upon the block-based hybrid video coding framework. FIG. 2B gives the block diagram of a generic block-based hybrid video encoding system. The input video signal is processed block by block (called coding units (CUs)). Different from the HEVC which partitions blocks only based on quad-trees, in the AVS3, one coding tree unit (CTU) is split into CUs to adapt to varying local characteristics based on quad/binary/extended-quad-tree. Additionally, the concept of multiple partition unit type in the HEVC is removed, i.e., the separation of CU, prediction unit (PU) and transform unit (TU) docs not exist in the AVS3; instead, each CU is always used as the basic unit for both prediction and transform without further partitions. In the tree partition structure of the AVS3, one CTU is firstly partitioned based on a quad-tree structure. Then, each quad-tree leaf node can be further partitioned based on a binary and extended-quad-tree structure. As shown in FIG. 2C-2G, there are five splitting types, quaternary partitioning (FIG. 2C), vertical binary partitioning (FIG. 2D), horizontal binary partitioning (FIG. 2E), vertical extended quad-tree partitioning (FIG. 2F), and horizontally extended quad-tree partitioning (FIG. 2G). In FIG. 2B, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and then quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used as reference to code future video blocks. To form the output video bit-stream, coding mode (inter or intra), prediction mode information, motion information, and quantized residual coefficients are all sent to the entropy coding unit to be further compressed and packed.

The first version of the HEVC standard was finalized in October 2013, which offers approximately 50% bit-rate saving or equivalent perceptual quality compared to the prior generation video coding standard H.264/MPEG AVC. Although the HEVC standard provides significant coding improvements than its predecessor, there is evidence that superior coding efficiency can be achieved with additional coding tools over HEVC. Based on that, both VCEG and MPEG started the exploration work of new coding technologies for future video coding standardization. one Joint Video Exploration Team (JVET) was formed in October 2015 by ITU-T VECG and ISO/IEC MPEG to begin significant study of advanced technologies that could enable substantial enhancement of coding efficiency. One reference software called joint exploration model (JEM) was maintained by the JVET by integrating several additional coding tools on top of the HEVC test model (HM).

In October 2017, the joint call for proposals (CfP) on video compression with capability beyond HEVC was issued by ITU-T and ISO/IEC. In April 2018, 23 CfP responses were received and evaluated at the 10-th JVET meeting, which demonstrated compression efficiency gain over the HEVC around 40%. Based on such evaluation results, the JVET launched a new project to develop the new generation video coding standard that is named as Versatile Video Coding (VVC). In the same month, one reference software codebase, called VVC test model (VTM), was established for demonstrating a reference implementation of the VVC standard.

Like HEVC, the VVC is built upon the block-based hybrid video coding framework. FIG. 2B gives the block diagram of a generic block-based hybrid video encoding system. The input video signal is processed block by block (called coding units (CUs)). In VTM-1.0, a CU can be up to 128×128 pixels. However, different from the HEVC which partitions blocks only based on quad-trees, in the VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure. As shown in FIGS. 2C-2G, there are five splitting types, quaternary partitioning (FIG. 2C), vertical binary partitioning (FIG. 2D), horizontal binary partitioning (FIG. 2E), vertical extended quad-tree partitioning (FIG. 2F), and horizontally extended quad-tree partitioning (FIG. 2G). In FIG. 2B, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used to code future video blocks. To form the output video bit-stream, coding mode (inter or intra), prediction mode information, motion information, and quantized residual coefficients are all sent to the entropy coding unit to be further compressed and packed to form the bit-stream.

FIG. 3A is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2A. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some embodiments, a unit of the video decoder 30 may be tasked to perform the implementations of the present application. Also, in some embodiments, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some embodiments, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3A or 3B. But it will be apparent to one skilled in the art that the video data memory 79 and the DPB 92 may be provided by the same memory device or separate memory devices. In some embodiments, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some embodiments, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some embodiments, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples. FIG. 4 is an illustration of an LFNST process according to one example of the present disclosure.

FIG. 3B gives a general block diagram of a block-based video decoder. Exemplarily, FIG. 3B illustrates a general video decoder for, not limited to, an AVS3. The video bit-stream is first entropy decoded at entropy decoding unit. The coding mode and prediction information are sent to either the spatial prediction unit (if intra coded) or the temporal prediction unit (if inter coded) to form the prediction block. The residual transform coefficients are sent to inverse quantization unit and inverse transform unit to reconstruct the residual block. The prediction block and the residual block are then added together. The reconstructed block may further go through in-loop filtering before it is stored in reference picture store. The reconstructed video in reference picture store is then sent out for display, as well as used to predict future video blocks.

Moreover, ITU-T VCEG (Q6/16) and ISO/IEC MPEG (JTC 1/SC 29/WG 11) are studying the potential need for standardization of future video coding technology with a compression capability that significantly exceeds that of the current VVC standard. Such future standardization action could either take the form of additional extension(s) of VVC or an entirely new standard. The groups are working together on this exploration activity in a joint collaboration effort known as the Joint Video Exploration Team (JVET) to evaluate compression technology designs proposed by their experts in this area. The first Exploration Experiments (EE) were established in JVET meeting during 6-15 Jan. 2021 and this exploration software model is named as Enhanced Compression Model (ECM) and ECM version2 (ECM2.0) is released on August 2021.

As shown in FIG. 3C, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 3D, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 3E, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 3F depicts a quad-tree data structure illustrating the end result of the partition process of the CTU 400 as depicted in FIG. 3E, each leaf node of the quad-tree corresponding to one CU of a respective size ranging from 32×32 to 8×8. Like the CTU depicted in FIG. 3D, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 3E and 3F is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 3G-3K, there are five possible partitioning types of a coding block having a width W and a height H, i.e., quaternary partitioning (FIG. 3G), horizontal binary partitioning (FIG. 3I), vertical binary partitioning (FIG. 3H), horizontal ternary partitioning (FIG. 3K), and vertical ternary partitioning (FIG. 3J).

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Ch sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 3E, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some embodiments, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Ch coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2A, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

This disclosure focuses on the improvement of the coding efficiency of transform in video coding. More specifically, the training and coding methods of Karhunen-Loève Transform (KLT) are proposed. In the following sections, related works are firstly reviewed. Then, the proposed KLT training and signaling methods are introduced.

Large Block-Size Transforms with High-Frequency Zeroing

In VVC, large block-size transforms, up to 64×64 in size, are enabled, which is primarily useful for higher resolution video, e.g., 1080p and 4K sequences. High frequency transform coefficients are zeroed out for the transform blocks with size (width or height, or both width and height) equal to 64, so that only the lower-frequency coefficients are retained. For example, for an M×N transform block, with M as the block width and N as the block height, when M is equal to 64, only the left 32 columns of transform coefficients are kept. Similarly, when N is equal to 64, only the top 32 rows of transform coefficients are kept. When transform skip mode is used for a large block, the entire block is used without zeroing out any values. In addition, transform shift is removed in transform skip mode. The VTM also supports configurable max transform size in SPS, such that encoder has the flexibility to choose up to 32-length or 64-length transform size depending on the need of specific implementation.

### Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII.

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

Table 1 shows the basis functions of the selected DST/DCT.

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

TABLE 1
Transform basis functions of DCT-II/VIII and DSTVII for N-point input

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to control MTS scheme, separate enabling flags are specified at SPS level for intra and inter, respectively. When MTS is enabled at SPS, a CU level flag is signalled to indicate whether MTS is applied or not. Here, MTS is applied only for luma. The MTS signaling is skipped when one of the below conditions is applied.
1). The position of the last significant coefficient for the luma TB is less than 1 (i.e., DC only)
2). The last significant coefficient of the luma TB is located inside the MTS zero-out region

If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 2. Unified the transform selection for ISP and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE 2
Transform and signalling mapping table

| | | | Intra/inter | |
|---|---|---|---|---|
| MTS_CU_flag | MTS_Hor_flag | MTS_Ver_flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also the implicit MTS can be still enabled when MTS is enabled for inter coded blocks.

### Low-Frequency Non-Separable Transform (LFNST)

In VVC, LFNST is applied between forward primary transform and quantization (at encoder) and between de-quantization and inverse primary transform (at decoder side) as shown in FIG. 4. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using an input block as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ] \qquad ( 3 - 1 )$$

is first represented as a vector [symbol] :

$$\vec{X} = {[ \begin{matrix}{X}_{00} & {X}_{01} & {X}_{02} & {X}_{03} & {X}_{10} & {X}_{11} & {X}_{12} & {X}_{13} & {X}_{20} & {X}_{21} & {X}_{22} & {X}_{23} & {X}_{30} & {X}_{31} & {X}_{32} & {X}_{33}\end{matrix} ]}^{T} \qquad ( 3 - 2 )$$

The non-separable transform is calculated as [symbol] =T· [symbol] , where [symbol] indicates the transform coefficient vector, and T is a 16×16 transform matrix. The 16×1 coefficient vector [symbol] is subsequently re-organized as 4×4 block using the scanning order for that block (horizontal, vertical or diagonal). The coefficients with smaller index will be placed with the smaller scanning index in the 4×4 coefficient block.

### Reduced Non-Separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes an R×N matrix as follows:

$${T}_{R \times N} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {t}_{R 3} & … & {t}_{RN}\end{matrix} ] \qquad ( 3 - 3 )$$

where the R rows of the transform matrix are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 matrices with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### LFNST Transform Selection

There are totally 4 transform sets and 2 non-separable transform matrices (kernels) per transform set are used in LFNST. The mapping from the intra prediction mode to the transform set is pre-defined as shown in Table 3. If one of three CCLM modes (INTRA_LT_CCLM, INTRA_T_CCLM or INTRA_L_CCLM) is used for the current block (81<=predModeIntra<=83), transform set 0 is selected for the current chroma block. For each transform set, the selected non-separable secondary transform candidate is further specified by the explicitly signalled LFNST index. The index is signalled in a bit-stream once per Intra CU after transform coefficients.

TABLE 3
Transform selection table

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

LFNST Index Signaling and Interaction with Other Tools

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST is allowed is restricted to 64×64. Note that LFNST is enabled with DCT2 only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

### LFNST Training

The coding efficiency of LFNST highly depends on the design of LFNST kernels, which are derived by off-line training. The training process can be considered as a clustering problem, where each cluster represents a huge group of transform coefficient blocks retrieved from the actual encoding process, and the ‘centroid’ of each cluster is the optimal non-separable transform, i.e., KLT, for the associated transform coefficient blocks in the same cluster.

Enlightened by the classical k-means clustering method, the training of the LFNST is performed in a two-stage iterative manner with an initial state:

### Initialization

For each transform coefficient block collected from the encoding process, a random label, ranging from 0 to 3, is assigned. Then the low-frequency M×N coefficients are added as one training data in the cluster associated with the assigned label.

For each cluster labeled from 1 to 3, the optimal non-separable transform is derived by the solving eigenvectors of a covariance matrix, e.g., singular value decomposition (SVD), which is calculated using the training data in the same cluster. In addition, an identity transform, which means no secondary transform is applied, is assigned as the centroid of the first cluster.

### Iteration

For each available training data, select the best transform kernel using rate-distortion optimization and relabel the training data using the selected transform kernel.

With the updated label of each training data, each cluster is updated, and the ‘centroids’ (transform kernels) of cluster labeled from 1 to 3 are updated accordingly. The identity transform is always assigned to cluster 0.

### Subblock Transform (SBT)

In VTM, subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

When SBT is used for an inter-coded CU, SBT type and SBT position information are signaled in the bitstream. There are two SBT types and two SBT positions, as indicated in FIGS. 5A-5D. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIGS. 5A-5D. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.

The SBT is not applied to the CU coded with combined inter-intra mode.

### Transform Improvement in the ECM

### Maximum Transform Size and Zeroing-Out of Transform Coefficients

Both CTU size and maximum transform size (i.e., all MTS transform kernels) are extended to 256, where the maximum intra coded block can have a size of 128×128. The maximum CTU size is set to 256 for UHD sequences and it is set to 128, otherwise. In the primary transformation process, there is no normative zeroing out operation applied on transform coefficients. However, if LFNST is applied, the primary transform coefficients outside the LFNST region are normatively zeroed-out.

### Enhanced MTS for Intra Coding

In the current VVC design [1], for MTS, only DST7 and DCT8 transform kernels are utilized which are used for intra and inter coding.

Additional primary transforms including DCT5, DST4, DST1, and identity transform (IDT) are employed. Also MTS set is made dependent on the TU size and intra mode information. 16 different TU sizes are considered, and for each TU size 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients. The sum is compared against the two fixed thresholds to determine the total number of allowed MTS candidates:
1 candidate: sum<=th0
4 candidates: th0<sum<=th1
6 candidates: sum>th1

Note, although a total of 80 different classes are considered, some of those different classes often share exactly same transform set. So there are 58 (less than 80) unique entries in the resultant LUT.

For angular modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

LFNST Extension with Large Kernel

The LFNST design in VVC is extended as follows:

The number of LFNST sets(S) and candidates (C) are extended to S=35 and C=3, and the LFNST set (IfnstTrSetIdx) for a given intra mode (predModeIntra) is derived according to the following formula:
For predModeIntra<2, IfnstTrSetIdx is equal to 2
IfnstTrSetIdx=predModeIntra, for predModeIntra in [0,34]
lfnstTrSetIdx=68-predModeIntra, for predModeIntra in [35,66]

Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The kernel dimensions are specified by:
(LFSNT4, LFNST8*, LFNST16*)=(16×16, 32×64, 32×96)

The forward LFNST is applied to top-left low frequency region, which is called Region-Of-Interest (ROI). When LFNST is applied, primary-transformed coefficients that exist in the region other than ROI are zeroed out, which is not changed from the VVC standard.

The ROI for LFNST16 is depicted in FIG. 6. It consists of six 4×4 sub-blocks, which are consecutive in scan order. Since the number of input samples is 96, transform matrix for forward LFNST16 can be R×96. R is chosen to be 32 in this contribution, 32 coefficients (two 4×4 sub-blocks) are generated from forward LFNST16 accordingly, which are placed following coefficient scan order.

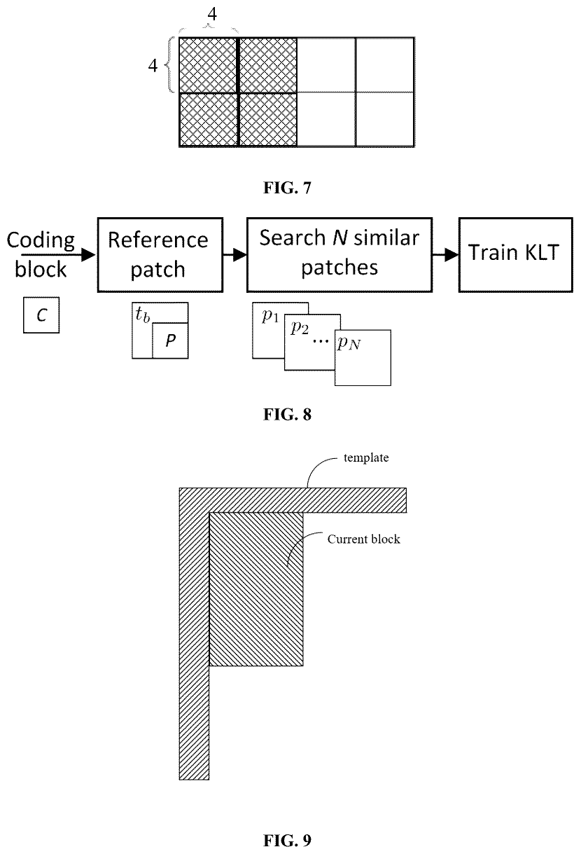

The ROI for LFNST8 is shown in FIG. 7. The forward LFNST8 matrix can be R×64 and R is chosen to be 32. The generated coefficients are located in the same manner as with LFNST16.

The mapping from intra prediction modes to these sets is shown in Table 4A and Table 4B.

TABLE 4A
Mapping of intra prediction modes to LFNST set index

| Intra pred. mode | −14 | −13 | −12 | −11 | −10 | −9 | −8 | −7 | −6 | −5 | −4 | −3 | −2 | −1 |
|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 |
| Intra pred. mode | 18 | 19 | 20 | 21 | 22 | 23 | 24 | 25 | 26 | 27 | 28 | 29 | 30 | 31 |
| LNFST set index | 18 | 19 | 20 | 21 | 22 | 23 | 24 | 25 | 26 | 27 | 28 | 29 | 30 | 31 |
| Intra pred. mode | 50 | 51 | 52 | 53 | 54 | 55 | 56 | 57 | 58 | 59 | 60 | 61 | 62 | 63 |
| LFNST set index | 18 | 17 | 16 | 15 | 14 | 13 | 12 | 11 | 10 | 9 | 8 | 7 | 6 | 5 |

TABLE 4B
Mapping of intra prediction modes to LFNST set index

| Intra pred. mode | 0 | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|---|
| LFNST set index | 0 | 1 | 2 | 3 | 4 | 5 | 6 | 7 | 8 | 9 | 10 | 11 | 12 | 13 | 14 | 15 | 16 | 17 |
| Intra pred. mode | 32 | 33 | 34 | 35 | 36 | 37 | 38 | 39 | 40 | 41 | 42 | 43 | 44 | 45 | 46 | 47 | 48 | 49 |
| LNFST set index | 32 | 33 | 34 | 33 | 32 | 31 | 30 | 29 | 28 | 27 | 26 | 25 | 24 | 23 | 22 | 21 | 20 | 19 |

| Intra pred. mode | 64 | 65 | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|---|---|
| LFNST set index | 4 | 3 | 2 | 2 | 2 | 2 | 2 | 2 | 2 | 2 | 2 | 2 | 2 | 2 | 2 | 2 | 2 |

### Signal Dependent Transform (SDT) in JEM

Considering that there are many similar patches within a frame and across frames, signal dependent transform explores such correlations can enhance coding performance by means of KLT. This trained KLT plays the role of a transform that is intended to compact the energy more efficiently.

The flowchart in FIG. 8 describes this idea. For the current coding block indicated by C, at first, a reference patch R which consists of the reconstructed left-up template t_{b} and the prediction block p of the coding block is obtained. Then, this reference patch is used to search for N most similar patches over the reconstructed regions. Finally, one-dimensional KLT based on these blocks and prediction block is calculated. The coding block is unknown at the decoder for the collection of similar candidate blocks. The prediction block and the reconstructed template are used to guide the searching of similar blocks instead of using the original block. This tool is used for various block sizes 4×4, 8×8, 16×16 and 32×32.

It is known that Karhunen-Loeve transform (KLT) is the optimal transform in terms of the energy compaction efficiency. By searching over the reconstructed regions, N blocks xᵢ, i=1, 2, . . . , N, which are most similar to the reference patch are obtained. Here, xᵢ=(xᵢ₁, xᵢ₂, . . . , x_{iD})^{T} and D indicates the vector dimension which is the transform block size. For an example, for 4×4 coding block, N is 16. The prediction p from those blocks is subtracted and obtain the residual blocks as uᵢ, i=1, 2, . . . , N, where uᵢ=(xᵢ−p)\sqrt{N}. The, these residual blocks are used as the training samples with zero mean for the KLT derivation. These N training samples can be represented by U=(u₁, u₂, . . . , u_{N}), which is an D×N matrix. Consider the covariance matrix Σ as given by:

$$\sum = {UU}^{T} \qquad ( 3 - 4 )$$

where the dimension of this covariance matrix is D×D. KLT bases are then the eigenvectors of this covariance matrix. For natural image/video contents, we find the selection of the candidate number N as 100 is enough for the good performance.

The computation complexity for the eigenvalue decomposition is O(D³). For 4×4 block with D being 16, the complexity is O(16³), which is acceptable. For a large block, the complexity will be very high. For 32×32 block with D being 1024, the time complexity will be 262144 times slower than that for 4×4 block, being intolerable in the coding framework.

In considering this, a fast algorithm is used to make the large block size KLT feasible. The dimension of Σ is D×D. However, UTU has a much lower dimension as N×N. We calculate the eigenvectors ϕ of Σ′=U^{T}U, which satisfy the equation as

$${U}^{T} U ϕ = ϕ Λ \qquad ( 3 - 5 )$$

ϕ indicates the eigenvector matrix while A denotes the diagonal matrix with the eigenvalues being the diagonal elements. Let's multiply both sides of Equation (3-5) by U to get

$${UU}^{T} U ϕ = U ϕ Λ \qquad ( 3 - 6 )$$

Add brackets to this equation and obtain

$$( {UU}^{T} ) ( U ϕ ) = ( U ϕ ) Λ \qquad ( 3 - 7 )$$

The column vectors of Uϕ are the eigenvectors of UU^{T} with their corresponding eigenvalues being the diagonal elements of matrices Λ. Let φ=Uϕ. This indicates the eigenvectors of the high dimensional covariance matrix UU^{T} can be obtained by multiplying U with the eigenvectors ϕ which are obtained from the low dimensional covariance matrix U^{T}U. The dimensions of φ and Λ are both D×N. All the other (D−N) eigenvectors of UU^{T} have zero eigenvectors. We can use Schmidt orthogonalization to fill these (D−N) eigenvectors to get D×D eigenvector matrix.

To reduce the complexity for matrix multiplication, one can use the obtained N eigenvectors to perform KLT transform, leaving the remaining (D−N) transform coefficients as zeros. This will not attenuate the performance since the first N projections can cover most of the signal energy while the bases are trained from samples being highly correlated with the coding block.

The described KLT is implemented at the block level on the coding block in the JEM. To have high adaptability to the image/video contents, the proposed scheme supports the proposed KLT on 4×4, 8×8, 16×16 and 32×32 coding blocks. At the JEM encoder side, rate-distortion optimization is used to determine the transform mode among the SDT and the adaptive multiple transform (AMT).

Extended Intra Prediction with Wide-Angle Intra Modes

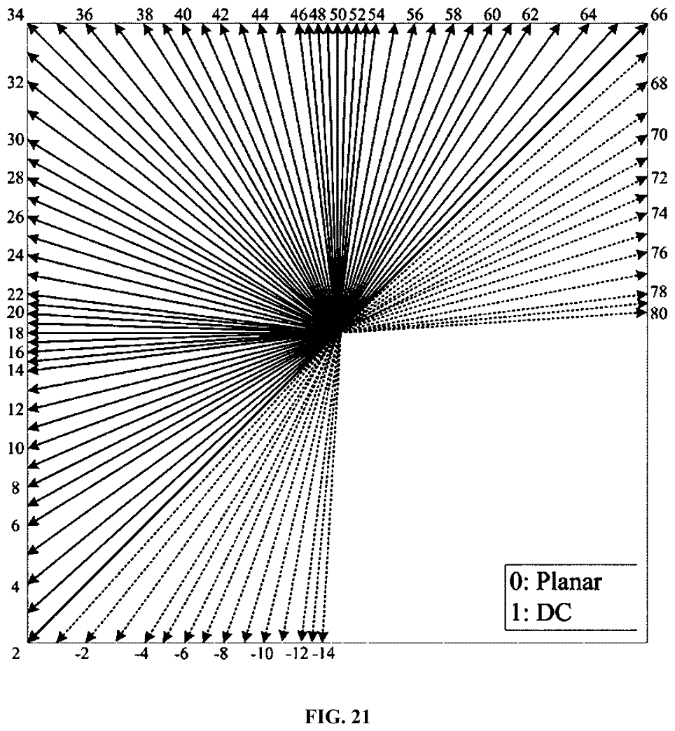

Like HEVC, VVC uses a set of reference samples neighboring a current CU (i.e., above the current CU or left to the current CU) to predict samples of the current CU. However, to capture finer edge directions present in natural video (especially for video content in high resolutions, e.g., 4K), a number of angular intra modes is extended from 33 in HEVC to 93 in VVC. FIG. 21 illustrates a diagram of intra modes as defined in VVC and the ECM. As shown in FIG. 21, among the 93 angular intra modes, modes 2 to 66 are conventional angular intra modes, and modes−1 to −14 and modes 67 to 80 are wide-angle intra modes. In addition to the angular intra modes, the planar mode (mode 0 in FIG. 1) and Direct Current (DC) mode (mode 1 in FIG. 21) of HEVC are also applied in VVC.

Since a quad/binary/ternary tree partition structure is applied in VVC, besides video blocks in square shape, rectangular video blocks also exist for the intra prediction in VVC. Due to unequal width and height of one given video block, various sets of angular intra modes may be selected from the 93 angular intra modes for different block shapes. More specifically, for both square and rectangular video blocks, besides planar and DC modes, 65 angular intra modes among the 93 angular intra modes are also supported for each block shape. When a rectangular block shape of a video block satisfies a certain condition, an index of a wide-angle intra mode of the video block may be adaptively determined by the video decoder 30 according to an index of a conventional angular intra mode received from the video encoder 20 using a mapping relationship as shown in Table 5 below. That is, for non-square blocks, the wide-angle intra modes are signaled by the video encoder 20 using the indexes of the conventional angular intra modes, which are mapped to indexes of the wide-angle intra modes by the video decoder 30 after being parsed, thus ensuring that a total number (i.e., 67) of intra modes (i.e., the planar mode, the DC mode and 65 angular intra modes among the 93 angular intra modes) is unchanged, and the intra mode coding method is unchanged. As a result, a good efficiency of signaling intra modes is achieved while providing a consistent design across different block sizes.

Table 5 shows a mapping relationship between indexes of conventional angular intra modes and indexes of wide-angle intra modes for the intra prediction of different block shapes in VCC, wherein W represents a width of a video block, and H represents a height of the video block.

TABLE 5

| | | Indexes of | Indexes of |
|---|---|---|---|
| | | conventional | wide-angle |
| Block shape | Aspect ratio | angular intra modes | intra modes |
| Square, | W/H == 1 | None | None |
| W = H | | | |
| Flat | W/H == 2 | 2, 3, 4, 5, 6, 7, 8, 9 | 67, 68, 69, 70, 71, |
| rectangle, | | | 72, 73, 74 |
| W > H | W/H == 4 | 2, 3, 4, 5, 6, 7, 8, 9, | 67, 68, 69, 70, 71, |
| | | 10, 11 | 72, 73, 74, 75, 76 |
| | W/H == 8 | 2, 3, 4, 5, 6, 7, 8, | 67, 68, 69, 70, 71, |
| | | 9, 10, 11, 12, 13 | 72, 73, 74, 75, 76, |
| | | | 77, 78 |
| | W/H == 16 | 2, 3, 4, 5, 6, 7, 8, 9, | 67, 68, 69, 70, 71, |
| | | 10, 11, 12, 13, 14, 15 | 72, 73, 74, 75, 76, |
| | | | 77, 78, 79, 80 |
| Tall | W/H == 1/2 | 59, 60, 61, 62, 63, 64, | −8, −7, −6, −5, −4, |
| rectangle, | | 65, 66 | −3, −2, −1 |
| W < H | W/H == 1/4 | 57, 58, 59, 60, 61, 62, | −10, −9, −8, −7, −6, |
| | | 63, 64, 65, 66 | −5, −4, −3, −2, −1 |
| | W/H == 1/8 | 55, 56, 57, 58, 59, 60, | −12, −11, −10, −9, |
| | | 61, 62, 63, 64, 65, 66 | −8, −7, −6, −5, |
| | | | −4, −3, −2, −1 |
| | W/H == 1/16 | 53, 54, 55, 56, 57, 58, | −14, −13, −12, −11, |
| | | 59, 60, 61, 62, 63, 64, | −10, −9, −8, −7, −6, |
| | | 65, 66 | −5, −4, −3, −2, −1 |

The transform in the VVC and ECM has been designed more efficiently than that in the HEVC, both in the transform cores and signaling methods. More methods which aim to further improve the performance of transform coding have been proposed in the past decade, including MTS, LFNST, SDT and so on. However, there are still several drawbacks in these methods.

In the current VVC and ECM, the primary transform cores are derived from DCT and DST formulas. However, the derived transform cores may not adapt to all the video contents with different characteristics. Therefore, more efficient transform cores remain to be investigated.

In the current VVC and ECM, the transform matrices in LFNST are actually trained KLT. However, LFNST is only applied in the secondary transform. The KLT in the primary transform is not considered.

The signal dependent transform (SDT) in the JEM can achieve significant coding gain. However, the KLT matrices in SDT need to be online derived at both the encoder and decoder side by template matching. The complexity of template matching and eigenvalue decomposition is not acceptable especially for the decoder.

To train the KLT, training data should be collected firstly. In the SDT (online KLT training), training data is collected by template matching at both encoder and decoder side, which is too complex. In LFNST, all the transform blocks with different block sizes are firstly collected and these blocks are then divided into K groups using clustering method. Then one KLT matrix is derived for each group. In video coding, one index is signaled for each CU to indicate which transform matrix is used, i.e., which group the current transform block belongs to. This method may suffer from two drawbacks. Firstly, the training data classification is to divide the training data into different groups to guarantee that the training samples in one group conform to the same statistical characteristics. However, the training data classification in LFNST maybe not accurate enough. Secondly, the singled index at CU level also brings additional overhead bits.

In the current VVC and ECM, the transform cores are fixed which cannot adapt to the non-stationary characteristics of video contents.

In the current video coding standard, the forward and inverse transform share the same transform matrix to guarantee the perfect reconstruction. However, due to the quantization of transform coefficients, the perfect reconstruction cannot be guaranteed and the transform matrix sharing may not lead to the optimal compression performance.

In the current VVC and ECM, secondary transform termed as LFNST is applied to the transform block in which MTS is not applied, i.e., DCT-II is applied to both horizontal and vertical transforms. However, LFNST is neglected for the transform block coded with the MTS.

To tackle the above-mentioned problems of KLT in video coding, several methods are proposed to improve the performance of KLT in video coding: (i) This disclosure proposes an offline trained KLT method for the primary transform; (ii) To improve the performance of the trained KLT, more efficient transform block (including the training data) classification methods are proposed; (iii) To deal with the diverse video statistical characteristics, the KLT matrices adaptive signaling methods are also proposed; (iv) To handle the quantization effect of transform coefficients, asymmetric KLT is proposed in which the forward and inverse transform may use different transform matrices; and (v) In this disclosure, it is proposed to enable LFNST for MTS.

In this section, KLT is firstly introduced briefly. Then the proposed KLT training and signaling methods are further proposed.

### A Brief Introduction of KLT

KLT is a kind of orthogonal transform based on the statistical property of the signal, which can achieve the optimal transform gain in terms of mean square error (MSE) metric. KLT is a linear transform where the basis functions are taken from the statistics of the signal, and can thus be adaptive. It is optimal in the sense of energy compaction, i.e., it places as much energy as possible in as few coefficients as possible. Denote the input vector as x, the output vector of KLT as X. The correlation between any two elements in X is zero, i.e.,

$$E [ ( X [ {u}_{1} ] - \overline{X} [ {u}_{1} ] ) ( X [ {u}_{2} ] - \overline{X} [ {u}_{2} ] ) ] = 0 \qquad ( 5 - 1 )$$

The above Equation (5-1) is further converted as the following form:

$$E [ X [ {u}_{1} ] X [ {u}_{2} ] ] - \overline{X} [ {u}_{1} ] \overline{X} [ {u}_{2} ] = 0 \qquad ( 5 - 2 )$$

If it is assumed that the input vector x is a zero-mean variable, then X̅[u₁]X̅[u₂]=0 (u₁≠u₂). Equation (5-2) is converted as

$$E [ X [ {u}_{1} ] X [ {u}_{2} ] ] = 0 \qquad ( 5 - 3 )$$

In this disclosure, the KLT matrix is denoted as K, the transform can be described as follow:

$$X = Kx \qquad ( 5 - 4 )$$

The covariance matrix of the X can be described as:

$$E [ {XX}^{T} ] = E [ {Kxx}^{T} {K}^{T} ] = KE [ {xx}^{T} ] {K}^{T} = {KCK}^{T} \qquad ( 5 - 5 )$$

Where C is the covariance matrix of the input vector. To ensure that E[X [u₁]X[u₂]=0, E[XX^{T}] must be a diagonal matrix. In the other words, matrix K must transform matrix C into a diagonal matrix. That is to say the row vectors of matrix K are eigenvectors of matrix C.

### KLT Training

To derive the KLT for the signal, the statistical properties should be known, i.e., the covariance matrix of the signal. However, in practice it is difficult to obtain the covariance matrix of the signal since the probability distribution is not available. Therefore, in the practical application, the KLT derivation is usually based on training from data. There are several issues in the training-based KLT derivation.

The first issue is that given the training set how to derive the corresponding KLT matrix.

The second issue is how to collect and classify training samples into different groups, in each group the training samples share the same statistical distribution.

### KLT Training Method

In this disclosure, KLT may be trained using singular value decomposition (SVD) or eigenvalue decomposition given the training data. Firstly, it is assumed that we have collected a set of training data with zero mean for the KLT, which consists of N blocks, xᵢ, i=1, 2, . . . , N where xᵢ=(xᵢ1, . . . , x_{iD})^{T} and D represents the dimension of the vector which is just the transform block size. The training samples are normalized as uᵢ=xᵢ/\sqrt{N}. Then, we take these residual blocks as the training samples with zero means for deriving KLT. These N training samples can be represented by U=(u₁, . . . , u_{N}), which is a D×N matrix. We denote the covariance matrix Σ of those training blocks as:

$$\sum = {UU}^{T} \qquad ( 5 - 6 )$$

where the dimension of Σ is D×D. The relationship between this covariance matrix and its eigenvectors is as

$$\sum Ψ = ΨΛ \qquad ( 5 - 7 )$$

where Ψ is the transform matrix with the column vectors being the eigenvectors (KLT bases) and Λ is a diagonal matrix with the diagonal elements being the eigenvalues. The eigenvectors can be obtained by performing eigenvalue decomposition or SVD on the covariance matrix. Note that we have sorted the eigenvalues together with the eigenvectors in descending order of the eigenvalues. This is to let the energy of the transform coefficients have descending order corresponding to the training samples.

### Training Data Clustering

In the proposed KLT training method, the samples are transform blocks retrieved from the encoding process. Then these samples are clustered into different groups and each KLT matrix is derived for each group.

Embodiment 1: In this embodiment, the training samples are clustered based on the transform block size. For example, for each block size, one KLT matrix is derived.

Embodiment 2: In this embodiment, for intra prediction, the training samples are clustered based on transform block size and intra mode. For example, for each transform block size, a set of KLT matrices are derived, in which one intra mode corresponds to one KLT matrix or several intra modes share one KLT matrix.

In this embodiment, for inter prediction the training samples are clustered based on transform block size and AMVR mode. For example, for each transform block size, a set of KLT matrices are derived, in which one AMVR mode corresponds to one KLT matrix.

Embodiment 3: In this embodiment, for inter prediction the training samples are clustered based on transform block size and the absolute value of motion vector (MV). Several thresholds th₁, th₂, . . . , th_{M} are predefined to classify the motion vector. For example, for each transform block size, a set of KLT matrices are derived, in which one absolute value range of the motion vector corresponds to one KLT matrix. Here, the motion vector used for classification is the maximum value of horizontal MV and vertical MV values for both uni-prediction and bi-prediction.

Embodiment 4: In this embodiment, for inter prediction the training samples are clustered based on transform block size, prediction mode and neighboring template. It should be noted that for intra prediction, the prediction mode here refers to intra direction. While for inter prediction, the prediction mode refers to AMVR mode or motion vector value or inter prediction direction and so on. FIG. 9 shows an example template used in this embodiment for a certain transform block size, which consists of N rows and N columns of reconstructed pixels.

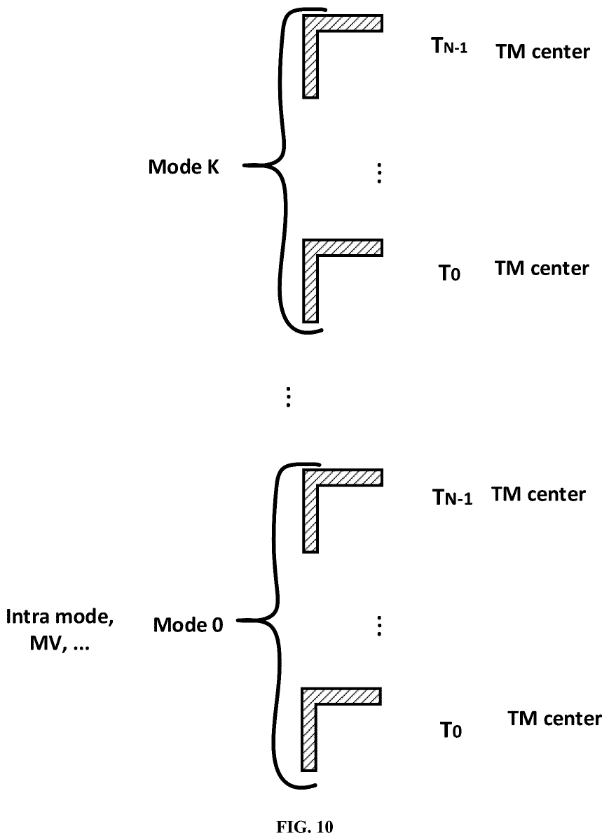

An example training process is illustrated as following. In the training set of each transform block size and prediction mode, the neighboring templates are divided into K clusters using classical k-means clustering based on a certain distance metric, including but not limited to sum of square error (SSE) and sum of absolute difference (SAD). Then for each transform block size and prediction mode, K template centers are derived and fixed at both the encoder and decoder, as illustrated in FIG. 10. For each (transform block size, prediction mode, template center), one training set is obtained and the corresponding KLT matrix is derived.

In encoding and decoding processes, for each transform block, the KLT transform set is firstly selected based on its block size and prediction mode. Then the distances between the template of the current block and the K template centers are calculated. The template center which leads to the minimum distance is selected and the corresponding KLT matrix is used for the current transform block.

Embodiment 5: In another embodiment, the proposed method in embodiment 4 is extended. In embodiment 4, for each (transform block size, prediction mode, template center), one KLT matrix is derived. In this embodiment, for each (transform block size, prediction mode, template center), the training set is further divided into several groups using classical k-means clustering as LFNST. In the encoding and decoding processes, for each (transform block size, prediction mode, template center) pair, a set of transform matrices are selected and an index used to further indicate which transform matrix in the set is used for the current block.

### OP-Dependent Primary Transform

In this disclosure, the QP-dependent primary transform is proposed. In the current VVC, ECM and the KLT transform methods, the primary transforms are QP independent, i.e., blocks with different QPs share the same transform matrices. In this disclosure, it is proposed to use different KLT transforms for different QPs. The KLT training process is described as follows. Firstly, the training data is collected using different QPs from the encoding process. Secondly, for each QP, the corresponding training set is utilized to derive the KLT matrices using the methods introduced above.

In the encoding and decoding process, for each transform block, in addition to the transform block size, prediction mode and neighboring template, its QP value is also utilized by the encoder or decoder to select the corresponding transform matrix.

### KLT for Wide-Angle Intra Modes

In this disclosure, different KLT matrices are trained for different intra prediction modes, i.e., for each intra prediction mode or intra prediction mode set, one KLT matrices set is trained. Here, the intra prediction mode set may consist of more than one intra prediction modes. As introduced above, wide-angle intra prediction modes are utilized for rectangular block in VVC and the ECM. Therefore, in this disclosure, KLT for wide-angle intra modes is considered. In one embodiment, only non-wide angular intra modes are utilized for KLT, i.e., 67 KLT matrices are trained for each block size in which each KLT matrix corresponds to one intra prediction mode ranging from 0 to 66. If the intra mode is wide angle for one block, the corresponding non-wide angle intra mode is utilized to select the corresponding KLT matrix.

In one embodiment, both wide and non-wide angular intra modes are utilized for KLT, i.e., each KLT matrix is trained for the intra mode ranging from −14˜80. Therefore, if a block is coded with wide-angle intra mode, the corresponding KLT matrix is identified and utilized for forward and inverse KLT.

### Asymmetric KLT

In the ordinary KLT, the forward transform and inverse transform share the same transform matrix to guarantee the perfect reconstruction property of the signal. However, in video/image coding, the transform coefficients are quantized after transform using a certain quantization parameter (QP). Therefore, the original signal cannot be reconstructed perfectly. To handle this problem, asymmetric KLT is proposed in this disclosure, in which the forward transform and inverse transform may use different transform matrices.

In the first embodiment, the transform units with the same size but coded using different QPs share the same forward KLT matrix while use different inverse KLT matrices. One example method to derive the forward and inverse KLT matrices is introduced as follows: (i) In the first step, for each TU size, the KLT matrix are derived for all the QP values according to the method described above. In this step, the derived forward KLT matrix and inverse KLT matrix share the same parameters; (ii) In the second step, the KLT matrices derived in the first step are integrated into video coder and the information of the TU using KLT is collected as the training data used in the following steps, including QP values, the original residues and the quantized transform blocks; and (iii) In the third step, the inverse KLT matrix are refined for each QP value or QP value range. The original residues and the quantized transform blocks for a certain QP value or QP value range are denoted as {r₁, r₂, . . . , r_{N}} and {ĉ₁, ĉ₂, . . . , ĉ_{N}}, respectively. The refinement of the inverse KLT matrix InvT can be described as follow.

InvT^{opt}=arg min Σᵢ₌₁^{N}D{rᵢ,InvT(ĉᵢ)}

In the second embodiment, the transform units with the same size but coded using different QPs share the same inverse KLT matrix while using different forward KLT matrices.

In the third embodiment, the transform units with the same size may use separate forward and inverse KLT matrices pair for different QPs, in which the forward and inverse matrices in each pair may have different matrix elements.

According to the one or more embodiments of the asymmetric KLT, for each TU size, several QP thresholds can be set: QP₁, QP₂, . . . , QP_{K}. These QP thresholds divide the QP values into K+1 ranges, and for each QP range, one set of forward/inverse KLT matrices are derived and applied.

### KLT Signaling in Video Coding

### KLT as Additional Primary Transform

In this disclosure, some embodiments on KLT signaling are proposed as follows.

In the first embodiment, it is proposed to apply high level on/off control of KLT. A flag is signaled at the SPS or PPS or slice header to indicate whether KLT is applied to the sequence or picture or slice.

In the second embodiment, it is proposed to use KLT as additional transform candidate of MTS. Firstly, MTS CU flag is signaled to indicate whether MTS is used for the current CU. If MTS CU flag is true, the KLT CU flag is signaled to indicate whether KLT is used as the primary transform of the CU. If MTS CU flag is true and KLT CU flag is false, the transform pairs in the current VVC or ECM are utilized. If more than one KLT matrices are used for the CU, an KLT index should be further signaled.

In the third embodiment, it is proposed to replace DCT2 and LFNST with KLT. Firstly, MTS CU flag is signaled to indicate whether MTS is used for the current CU. If MTS CU flag is false, KLT is applied to the CU, otherwise MTS is applied.

In the fourth embodiment, it is proposed to replace DCT2 (and LFNST) and MTS. If only one KLT is enabled for the CU, then the KLT is directly applied to the CU. If more than one KLT is enabled for the CU, one KLT index is signaled to indicate which KLT matrix is applied. In the fifth embodiment, it is proposed to apply KLT as LFNST, i.e., secondary transform of MTS. If MTS CU flag is true, then LFNST flag is signaled. If both MTS CU flag and LFNST flag is true and more than one LFNST is enabled for the CU, then one LFNST index is signaled to indicate which KLT matrix is applied.

### QP-Dependent Primary Transform

In this disclosure, the QP-dependent primary transform is proposed. In the current VVC, ECM and the KLT transform methods, the primary transforms are QP independent, i.e., blocks with different QPs share the same transform matrices. In this disclosure, it is proposed to use different KLT transforms for different QPs. The KLT training process is described as follows.

Firstly, the training data is collected using different QPs from the encoding process.

Secondly, for each QP, the corresponding training set is utilized to derive the KLT matrices using the methods introduced in the section of KLT training.

In the encoding and decoding processes, for each transform block, in addition to the transform block size, prediction mode and neighboring template, its QP value is also utilized to select the corresponding transform matrix.

In this disclosure, methods and apparatus are proposed to derive KLT matrices and apply these new matrices in video coding. Firstly, the algorithms of the KLT training are introduced. Secondly, the improved KLT training data clustering methods are proposed. Finally, the signaling methods of KLT in video coding is proposed. It is expected to further improve the coding efficiency of transform coding in the VVC and ECM.

### Adaptive KLT Matrix Signaling in Video Coding

In the above sections, the training and block level signaling methods are proposed and described. More specifically, the trained KLT matrices are fixed at both the encoder and the décor. In some embodiments, the statistical characteristics of video contents are usually time-variant (e.g., the statistical characteristics may vary for different frames or videos sequences). In these cases, it is difficult for the fixed KLT matrices to achieve optimal compression efficiency. High level adaptive KLT matrices can address this problem.

In one example, KLT matrices are adaptively signaled in a sequence parameter set (SPS). On the encoder side, the KLT matrices are derived for the sequence and are signaled in the SPS header.

In one example, KLT matrices are adaptively signaled in the picture parameter set (PPS). On the encoder side, the KLT matrices are derived for each picture and are signaled in the PPS header.

In one example, KLT matrices are adaptively signaled in the slice header. On the encoder side, the KLT matrices are derived for each slice and are signaled in the slice header.

In addition, the elements of the KLT matrices can be coded directly using typical codes (e.g., exponential-golomb (EG) code), and/or the adaptive KLT matrices can be predicted using the fixed KLT matrices and the residues of the KLT matrices are further signaled using typical codes.

### High-level KLT Matrices Signaling

In the above sections, the training and block level signaling methods are proposed and described. More specifically, the trained KLT matrices are fixed at both encoder and decoder. In practical applications, the statistical characteristics of video contents are usually time-variant, i.e., the statistical characteristics may vary for different frames or video sequences. In these cases, it is difficult for the fixed KLT matrices to achieve the optimal compression efficiency. To tackle this problem of fixed KLT matrices, the high level adaptive KLT matrices signaling method is proposed in this disclosure: (i) In the first aspect, it is proposed to adaptively signal the KLT matrices in the sequence parameter set (SPS). At the encoder side, the KLT matrices are derived for the sequence. Then the KLT matrices are signaled in the SPS header; (2) In the second aspect, it is proposed to adaptively signal the KLT matrices in the picture parameter set (PPS). At the encoder side, the KLT matrices are derived for each picture. Then the KLT matrices are signaled in the PPS header; and (3) In the third aspect, it is proposed to adaptively signal the KLT matrices in the slice header. At the encoder side, the KLT matrices are derived for each slice. Then the KLT matrices are signaled in the slice header.

It should be noted that two methods are proposed in this disclosure to code the elements in the KLT matrices. In the first method, the elements in the KLT matrices are directly coded using typical codes, i.e., Exponential-Golomb (EG) code. In the second method, the adaptive KLT matrices are predicted using the fixed KLT matrices, then the residues of the KLT matrices are further signaled using typical codes.

### LENST for MTS

In the current VVC and ECM, LFNST is applied between forward primary transform and quantization (at encoder) and between de-quantization and inverse primary transform (at decoder side). It also should be noted that LFNST is only enabled when the MTS is not used in the primary transform, i.e., DCT-II is applied in both horizontal and vertical transform. When MTS is used in the primary transform, LFNST is not used. To further improve the coding performance of LFNST, it is proposed to apply LFNST to transform blocks coded with MTS. The proposed LFNST kernels may be trained or offline derived, and then fixed at both encoder and decoder side.

In one or more embodiments, there are totally 4 transform sets and 2 non-separable transform matrices (kernels) per transform set are used in the proposed LFNST for MTS. The mapping from the intra prediction mode to the transform set is pre-defined as shown in Table 3-10. If one of three CCLM modes (INTRA_LT_CCLM, INTRA_T_CCLM or INTRA_L_CCLM) is used for the current block (81<=predModeIntra<=83), transform set 0 is selected for the current chroma block. For each transform set, the selected non-separable secondary transform candidate is further specified by the explicitly signalled LFNST index. The index is signalled in a bit-stream once per Intra CU after transform coefficients.

In some other embodiments, there are 67 transform sets, i.e., for each intra prediction mode, a corresponding transform set is used and one non-separable transform matrix for each transform set is used in the proposed LFNST. If the CU is coded using TIMD mode, the intra mode is mapped to the transform index with the following method:

$$trIdx = ( intraMode < 2 ? intraMode : ( ( intraMode >> 1 ) + 1 ) )$$

where intramode is the intra mode and trIdx is the index for the LFNST transform set.

It should be noted the proposed LFNST for MTS may be used but not limited to the above described two schemes. Since LFNST is restricted to be applicable only if all coefficients outside the first coefficient sub-group are non-significant, LFNST index coding depends on the position of the last significant coefficient. If more than one transform matrices are used in each transform set, Ithe LFNST index needs to be signaled, which can be context coded (not) depend on intra prediction mode. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

### KLT Zeroing-Out

To reduce the computational complexity and the memory space of coefficients of the proposed KLT, zeroing-out of KLT is proposed in this disclosure, including the spatial domain zeroing-out and frequency domain zeroing-out.

In the spatial domain zeroing-out, the vector with dimension of N is mapped to a vector with dimension of K, where K is smaller than N. For a vector with dimension of N, the typical non-separable transform is the matrix multiplication between the KLT matrix and the vector, where the KLT matrix has the shape of N×N. In the proposed spatial domain zeroing-out method, the dimension of the forward KLT matrix is reduced from N×N to K×N. Accordingly, the inverse KLT matrix is the transpose of the forward KLT matrix with the dimension of N×K. Embodiments are proposed in this disclosure to derive the KLT for spatial domain zeroing-out. It should be noted that the method to derive the reduced KLT is not limited to the following embodiments.

In one embodiment, the KLT for the spatial domain zeroing-out is derived by discarding the eigenvectors in equation (5-7). Denote the KLT matrix as Ψ=[φ₁, φ₂, . . . , φ_{N}] with φᵢ being the eigenvectors (KLT bases). The eigenvectors can be obtained by performing eigenvalue decomposition or SVD on the covariance matrix. Note that we have sorted the eigenvalues together with the eigenvectors in descending order of the eigenvalues to make the energy of the transform coefficients have descending order corresponding to the training samples. In this embodiment, the eigenvectors with smaller eigenvalues are discarded. The reduced KLT matrix can be represented as follow:

$${Ψ}^{*} = [ {φ}_{1} , {φ}_{2} , … , {φ}_{K} ] , K < N$$

The proposed frequency domain zeroing-out is applied when KLT is used for the secondary transform of MTS. After the MTS is conducted on the residue block, the primary transform block is obtained. Only some primary transform coefficients are kept while other coefficients are discarded. FIG. 12A-D provide some example zeroing-out methods of the primary transform block, in which the blue part represents the area that transform coefficients are retained.

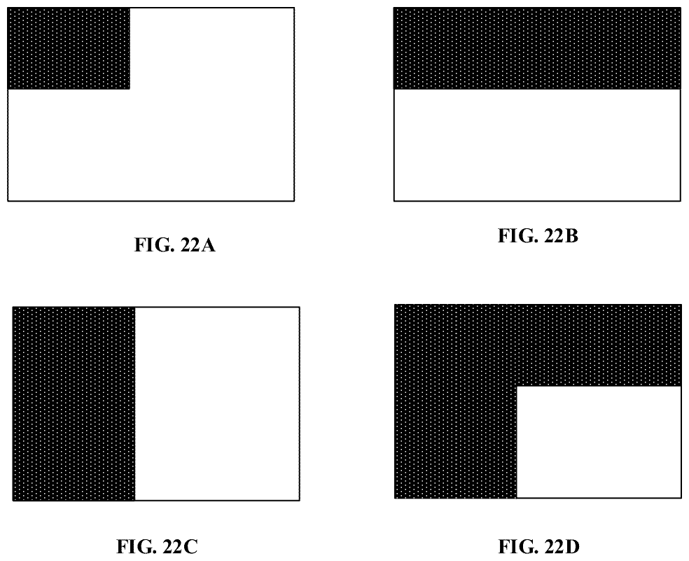

FIG. 22A provides an example that the transform coefficients in the left-above area are retained. FIG. 22B provides an example that the transform coefficients in the above area are retained. FIG. 22C provides an example that the transform coefficients in the left area are retained. FIG. 22D provides an example that the transform coefficients in the left and above areas are retained, where the left and above areas include both the above area and the left area.

In some embodiments, how to apply the zeroing-out methods may be illustrated in FIGS. 22A-D. In one embodiment, only one of the zeroing-out method in FIGS. 22A-D is applied for the primary transform block. In yet another embodiment, zeroing-out methods switch scheme is proposed. For each primary transform block, an index is signaled in the bitstream to indicate which zeroing-out method is applied to the block.

### KLT Matrix Sharing

In the proposed KLT, the residue block or primary transform block is firstly converted from a rectangular block to a vector. Take the following 4×2 block as an example.

$$X = [ \begin{matrix}{X}_{00} & {X}_{01} & {X}_{02} & {X}_{03} \\ {X}_{10} & {X}_{11} & {X}_{12} & {X}_{13}\end{matrix} ]$$

X is converted to a vector of eight dimensions using raster scan order or vertical scan order:

\vec{X}=[X₀₀ X₀₁ X₀₂ X₀₃ X₁₀ X₁₁ X₁₂ X₁₃] or X=[X₀₀ X₁₀ X₀₁ X₁₁ X₀₂ X₁₂ X₀₃ X₁₃]

KLT operation can be described as \vec{Y}=Ψ\vec{X}, where Ψ is the KLT matrix.

In the typical implementation, the training and derivation of KLT matrix is block shape dependent, i.e., different KLT matrices are trained for different block shapes. For example, different KLT matrices are used for the M×N block and N×M block when M is not equal to N.

To reduce the memory to store the coefficients of the KLT matrices, KLT matrix sharing methods are proposed in this disclosure. The basic idea of KLT kernel sharing is to share the same KLT matrix among the blocks with the same area. Several embodiments are proposed for the KLT matrix sharing.

In one embodiment, the blocks with the same area (number of samples in the block) share the same KLT matrix or KLT matrix set. For example, 16×4 block, 8×8 block and 4×16 block have different block shape, but the same KLT matrix is applied to these blocks.

In yet another embodiment, if the width of one block A is the same with the height of another block B, and the height of block A is the same with the width of block B, then block A and block B share the same KLT matrix or KLT matrix set. For example, H×W block and W×H block can share the same KLT matrix or KLT matrix set. In the embodiment, to use the shared KLT matrix, both the H×W block and W×H block are firstly converted to the vectors with the same dimension of W×H using certain scan orders.

In the first method, raster scan order, vertical scan order or any other scan order is applied to both the H×W block and W×H block to convert the blocks to the vectors.

In the second method, when converting the blocks to the vectors, raster scan order is applied to the block with the shape of W×H, while vertical scan order is applied to the block with the shape of H×W. Or vertical scan order is applied to the block with the shape of W×H, while raster scan order is applied to the block with the shape of H×W.

In the third method, any certain scan order (including but not limited to raster scan and vertical scan order) is applied to the block with the shape of W×H. The block with the shape of H×W is firstly transposed to the block with the shape of W×H. Then the scan order for the shape of W×H is applied to the transposed block to convert it into a vector.

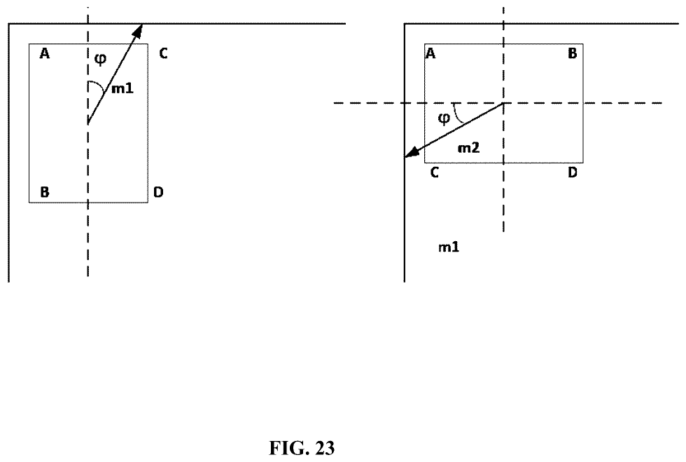

In embodiments of the present disclosure, the block is firstly converted to a vector with raster scan or vertical scan. In one example embodiment of KLT matrix sharing, for a block with size of W×H, if the height H is larger than its width W, the block is firstly transposed to a block with size of H×W as illustrated in FIG. 23 and then converted to a vector using raster scan or vertical scan. The corresponding KLT matrix is identified with the width, height and intra mode of the transposed block. As shown in FIG. 23, the W×H block before transposing is coded with intra mode of m1, i.e., the prediction direction is from bottom-left to above-right. However, after transposing the block, in addition to the change of the block shape, the prediction direction also changes, i.e., the intra mode is changed to m2. Therefore, the corresponding KLT matrix of the transposed block is identified with intra mode m2 instead of m1. From the perspective of the decoder, when the block with shape of W×H and intra mode m1 is a rectangular block and its height is larger than width, the shape of the transposed block and the mapped intra mode m2 is used to identify the KLT matrix. The mapped intra mode m2 is derived as follows.

In one embodiment, if wide-angle intra modes are not considered for KLT as described in the Section “KLT for Wide-Angle Intra Modes,” the mapped intra mode m2 is derived as follows:
If m1 is DC or planar mode, then m2=m1;
Otherwise, m2=68−m1

In yet another embodiment, if wide-angle intra modes are considered for KLT as described in the Section “KLT for Wide-Angle Intra Modes,” the mapped intra mode m2 is derived as follows:
If m1 is DC or planar mode, then m2=m1;
Else if −14<=m1<=−1, then m2=66−m1;
Otherwise, m2=68−m1

It should be noted that in the above example implementation, the block is transposed if its height is larger than its width. However, the proposed KLT matrix sharing method is not limited to this kind of implementation, other implementation methods are also allowed. For example, we may set that a block needs to be transposed if its width is larger than its height.

### Multiple KLT Kernels Selection

In the previous sections, for each block size and intra mode, only one KLT transform kernel is derived and applied. However, due to the diversity of the residue signal characteristics, one single transform kernel cannot capture all the signal distributions. To further improve the proposed KLT, in this disclosure multiple KLT kernel selection method is provided. In the multiple KLT kernel selection, for each block size and intra mode, more than one KLT transform kernels are derived and utilized. For signaling, the KLT flag is firstly signaled to indicate whether KLT is enabled. If KLT flag is true, the KLT kernel index is further signaled to indicate which KLT kernel is used for the current block.

In some embodiments of the present disclosure, the number of KLT kernels for each block size and intra mode is not limited. Also, the number of KLT kernels of different block size may be different. For example, three KLT kernels are derived for blocks with size of 4×4 while 4 KLT kernels are derived for blocks with size of 16×16.

Several embodiments are provided to signal the syntax elements for KLT with multiple kernels selection.

In one embodiment, the case of two KLT kernels is provided, that is for the blocks with certain size, two KLT kernels are derived. As shown in Table 6 below, in this embodiment, the first bin is context coded with context C0. If KLT is enabled, the second bin is then coded with context C1 to indicate which KLT kernel is utilized.

TABLE 6

| Binarized value | Context | Explanation |
|---|---|---|
| 0 | C₀ | KLT is not enabled |
| 10 | C₀C₁ | KLT kernel 1 is used |
| 11 | C₀C₁ | KLT kernel 2 is used |

In another embodiment, the case of two KLT kernels is provided, that is for the blocks with certain size, two KLT kernels are derived. As shown in Table 7 below, in this embodiment, the first bin is context coded with context C₀. If KLT is enabled, the second bin is then coded with bypass mode, i.e., equal probability to indicate which KLT kernel is utilized.

TABLE 7

| Binarized value | Context | Explanation |
|---|---|---|
| 0 | C₀ | KLT is not enabled |
| 10 | C₀E | KLT kernel 1 is used |
| 11 | C₀E | KLT kernel 2 is used |

In yet another embodiment, the case of three KLT kernels is provided, that is for the blocks with certain size, three KLT kernels are derived. As shown in Table 8 below, in this embodiment, the first bin is context coded with context C₀. If KLT is enabled, the second and third bins are then coded with context C₁ and C₂, respectively to indicate which KLT kernel is utilized.

TABLE 8

| Binarized value | Context | Explanation |
|---|---|---|
| 0 | C₀ | KLT is not enabled |
| 11 | C₀C₁ | KLT kernel 1 is used |
| 100 | C₀C₁C₂ | KLT kernel 2 is used |
| 101 | C₀C₁C₂ | KLT kernel 3 is used |

In yet another embodiment, the case of three KLT kernels is provided, that is for the blocks with certain size, three KLT kernels are derived. As shown in Table 9 below, in this embodiment, the first bin is context coded with context C₀. If KLT is enabled, the second bin is then coded with context C₁. The third bin is coded with bypass mode, i.e., equal probability.

TABLE 9

| Binarized value | Context | Explanation |
|---|---|---|
| 0 | C₀ | KLT is not enabled |
| 11 | C₀oC₁ | KLT kernel 1 is used |
| 100 | C₀C₁E | KLT kernel 2 is used |
| 101 | C₀C₁E | KLT kernel 3 is used |

In yet another embodiment, the case of four KLT kernels is provided, that is for the blocks with certain size, four KLT kernels are derived. As shown in Table 10 below, in this embodiment, the first bin is context coded with context C₀. If KLT is enabled, the second and third bins are then coded with context C₁ and C₂, respectively.

TABLE 10

| Binarized value | Context | Explanation |
|---|---|---|
| 0 | C₀ | KLT is not enabled |
| 111 | C₀C₁C₂ | KLT kernel 1 is used |
| 110 | C₀C₁C₂ | KLT kernel 2 is used |
| 100 | C₀C₁C₂ | KLT kernel 3 is used |
| 101 | C₀C₁C₂ | KLT kernel 4 is used |

In yet another embodiment, the case of four KLT kernels is provided, that is for the blocks with certain size, four KLT kernels are derived. As shown in Table 11 below, in this embodiment, the first bin is context coded with context C₀. If KLT is enabled, the second bin is then coded with context C₁. The third bin is coded with bypass mode, i.e., equal probability.

TABLE 11

| Binarized value | Context | Explanation |
|---|---|---|
| 0 | C₀ | KLT is not enabled |
| 111 | C₀C₁E | KLT kernel 1 is used |
| 110 | C₀C₁E | KLT kernel 2 is used |
| 100 | C₀C₁E | KLT kernel 3 is used |
| 101 | C₀C₁E | KLT kernel 4 is used |

In embodiments of the present disclosure, the following methods and apparatus are proposed to derive KLT matrices and apply these new matrices in video coding. The algorithms of the KLT training are introduced. The improved KLT training data clustering methods are proposed. The signaling methods of KLT in video coding are proposed. Asymmetric KLT method is proposed to handle the quantization effect of the transform coefficients. LFNST for MTS is also proposed to further improve the coding efficiency of LFNST. Finally, the high-level KLT matrices signaling methods are proposed. KLT zeroing-out methods are proposed to reduce the computational complexity and memory to store the KLT matrices. KLT matrix sharing methods are proposed to reduce the memory to store the KLT matrices. It is expected to further improve the coding efficiency of transform coding in the VVC and ECM.

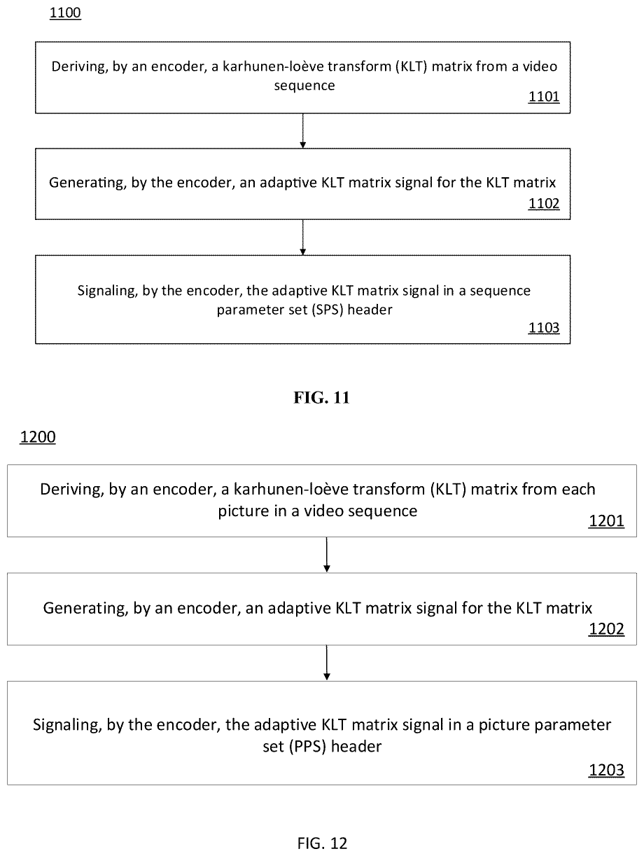

FIG. 11 is a flowchart illustrating a method 1100 according to an example of the present disclosure. The method 1100 includes deriving, by an encoder, a karhunen-loève transform (KLT) matrix from a video sequence, generating, by the encoder, an adaptive KLT matrix signal for the KLT matrix, and signaling, by the encoder, the adaptive KLT matrix signal in a sequence parameter set (SPS) header. By applying the mathematical techniques disclosed herein, the encoder identifies patterns and correlations among the pixel values, extracting various components of data. These various components (e.g., significant information regarding the video's spatial and temporal characteristics) are encapsulated in the KLT matrix.

At step 1101, the method 1100 includes deriving, by the encoder, a KLT matrix from a video sequence. In one example, the encoder calculates the KLT matrix. The KLT matrix captures statistical relationships between pixel values in the frame. The KLT matrix can be constructed using a subset of the sorted eigenvectors. The number of selected eigenvectors determines the dimensionality of the KLT matrix and the number of coefficients used to represent data.

Once the KLT matrix is derived, the encoder proceeds to generate an adaptive KLT matrix signal. The signal is designed to encapsulate the dynamic and adaptive nature of the KLT matrix itself. The adaptation takes into account the varying content and characteristics of the video sequence, ensuring that the signal accurately represents the transformation properties of the KLT matrix. The adaptive KLT matrix signal includes parameters and coefficients that enable the decoder to reconstruct the KLT matrix efficiently during the decoding process. By encoding these parameters in a structured manner, the encoder ensures that the adaptive signal effectively guides the decoder's transformation process to achieve optimal decompression results.

At step 1102, the method 1100 includes generating, by the encoder, an adaptive KLT matrix signal for the KLT matrix. The adaptive KLT matrix signal serves as a method to communicate the matrix's configuration to the decoder during the decoding process. The encoder calculates a specialized signal that encapsulates key characteristics and parameters of the adaptive KLT matrix. The signal is tailored to the specific statistical properties of the video sequence being compressed. In one example it encompasses factors such as the number of selected eigenvectors. The adaptive KLT matrix signal serves as a method to communicate the matrix's configuration to the decoder during the decoding process. By generating this signal, the encoder ensures that the decoder can replicate the KLT matrix.

At step 1103, the method 1100 includes signaling, by the encoder, the adaptive KLT matrix signal in a sequence parameter set (SPS) header. By embedding the signal in the SPS header, the encoder ensures that the decoder can generate a matching adaptive KLT matrix and perform the necessary transformations to achieve efficient video decompression. The SPS header encompasses a range of information that defines the properties and characteristics of the encoded video sequence (e.g., frame dimensions, aspect ratio, color format, bit depth, framerate, compression parameters, reference frame information, adaptive KLT matrix signal). Incorporating the adaptive KLT matrix signal into the SPS header maintains compatibility with established video coding standards. By embedding the adaptive KLT matrix signal within the SPS header, the discloses method ensures that the decoder has access to transformation information from the outset of the decoding process.

FIG. 12 is a flowchart illustrating a method 1200 for video encoding. The method 1200 may be implemented by an encoder. The method 1200 includes deriving, by an encoder, a KLT matrix from each picture in a video sequence, generating, by an encoder, an adaptive KLT matrix signal for the KLT matrix, and signaling, by the encoder, the adaptive KLT matrix signal in a picture parameter set (PPS) header. The PPS header contains a comprehensive array of information (e.g., picture dimensions, frame type, quantization parameters, motion vector data, reference picture information, and slice parameters) all of which collectively defines the properties and characteristics of each picture within the encoded video sequence. This information is meticulously structures and organized to enable the decoder to perform accurate frame reconstruction during the decoding process.

At step 1201, the method 1200 includes deriving, by the encoder, a KLT matrix from each picture in a video sequence. In one example, the encoder calculates a separate KLT matrix for each individual picture within a given video sequence. By generating the KLT matrix for each frame, the method captures statistical characteristics specific to each frame.

At step 1202, the method 1200 includes generating, by the encoder, an adaptive KLT matrix signal for the KLT matrix. The encoder calculates a specialized signal that encapsulates key characteristics and parameters of the adaptive KLT matrix. The signal is tailored to the specific statistical properties of the video sequence being compressed. In one example it encompasses factors such as the number of selected eigenvectors.

At step 1203, the method 1200 includes signaling, by the encoder, the adaptive KLT matrix signal in the PPS header. By embedding the signal in the PPS header, the encoder ensures that the decoder can generate a matching adaptive KLT matrix and perform the necessary transformations to achieve efficient video decompression.

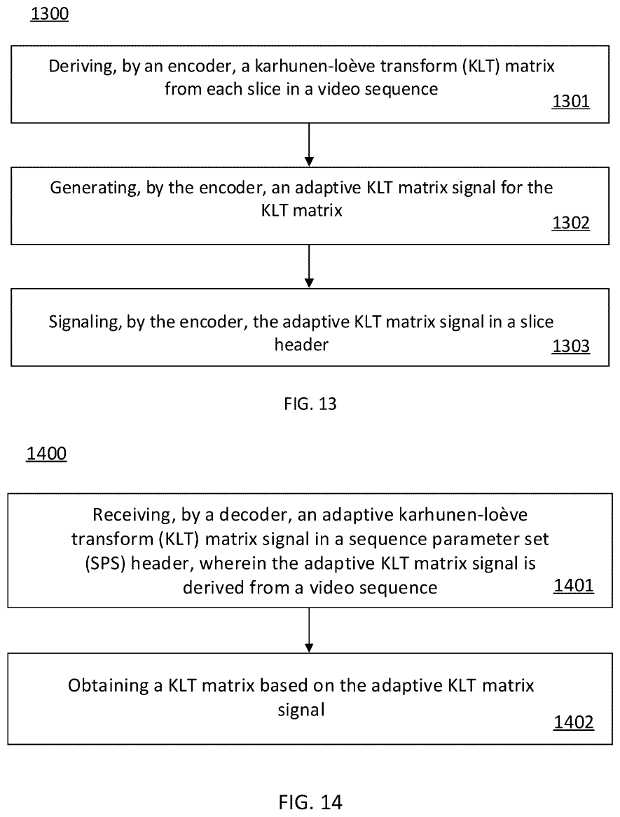

FIG. 13 is a flowchart illustrating a method 1300 for video encoding according to an example of the present disclosure. The method 1300 includes deriving, by an encoder, a KLT matrix from each slice in a video sequence, generating by an encoder, an adaptive KLT matrix signal for the KLT matrix, and signaling by the encoder, the adaptive KLT matrix signal in a slice header.

A slice can be conceptualized as a rectangular sub-region of a frame. It can span horizontally across several column and vertically across multiple rows, thereby constituting a coherent subset of the entire frame. Slices are particularly significant when dealing with video compression techniques, as they allow for efficient data processing and parallelization during both encoding and decoding procedures.

At step 1301, the method 1300 includes deriving, by the encoder, a KLT matrix from each slice in a video sequence. In one example, the encoder calculates separate KLT matrices for individual slices within a given video sequence. Each slice represents a distinctive portion of the video frame, often divided to facilitate parallel processing. By deriving a dedicated KLT matrix for each slice, the encoder can captures and compress data within a smaller region enhancing the overall compression efficiency.

At step 1302, the method 1300 includes generating, by the encoder, an adaptive KLT matrix signal for the KLT matrix. The signal is designed to convey essential characters and parameters associated with the adaptive KLT matrix. In one example, the parameters include the matrix's dimensions, the eigenvectors, and any adjustments that have been applied to align the matrix with specific attributes of the video sequence.

At step 1303, the method 1300 includes signaling, by the encoder, the adaptive KLT matrix signal in the slice header. By embedding the adaptive KLT matrix signal within the slice header, the encoder ensures that the decoder can accurately replicate the adaptive KLT matrix during the decoding process.

FIG. 14 is a flowchart illustrating a method 1400 for video decoding according to an example of the present disclosure. The method 1400 is implemented by a decoder. The method 1400 includes receiving, by a decoder, the adaptive KLT matrix signal in the SPS header, and obtaining the KLT matrix based on the adaptive KLT matrix signal. In one example, the adaptive KLT matrix signal is derived from a video sequence.

At step 1401, the method 1400 includes receiving, by a decoder, the adaptive KLT matrix signal in the SPS header. The adaptive KLT matrix signal is derived from a video sequence. In one example the decoder locates the SPS header in the compressed data and extracts the information contained within it. Extraction can include parsing the SPS header. In one example, the decoder first identifies and extracts various pieces of metadata embedded in the compressed video stream.

At step 1402, the method 1400 includes obtaining, by a decoder, a KLT matrix based on the adaptive KLT matrix signal. For example, the decoder uses the information from the adaptive KLT matrix signal to regenerate a KLT matrix that closely resembles the original adaptive KLT matrix. In one example, the decoded coefficients are transformed back to the original pixel domain using the inverse transformation of the generated KLT matrix.

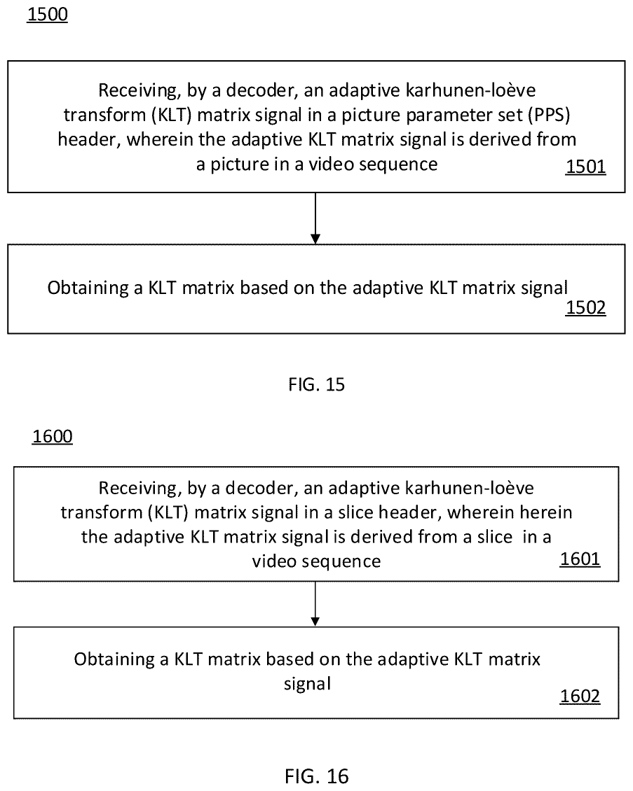

FIG. 15 is a flowchart illustrating a method 1500 for video decoding according to an example of the present disclosure. The method is implemented by the decoder. The method 1500 includes receiving, by the decoder, the adaptive KLT matrix signal in the PPS header, and obtaining a KLT matrix based on the adaptive KLT matrix signal. In one example, the adaptive KLT matrix signal is derived from a picture in the video sequence.

At step 1501, the method 1500 include receiving, by the decoder, the adaptive KLT matrix signal in the PPS header. In one example encoded data comprising the PPS header comprising the adaptive KLT matrix signal, is received by the decoder. The decoder extracts the PPS header from the encoded data to retrieve the adaptive KLT matrix signal.

At step 1502, the method 1500 includes, obtaining a KLT matrix based on the adaptive KLT matrix signal. Using the information from the adaptive KLT matrix signal, the decoder regenerates the adaptive KLT matrix that was used during the compression process and decodes coefficients used during the compression process.

FIG. 16 is a flowchart illustrating a method 1600 for video decoding according to an example of the present disclosure. The method 1600 includes receiving, by a decoder, the adaptive KLT matrix signal in the slice header, wherein the adaptive KLT matrix signal is derived from a slice in a video sequence (at step 1601), and obtaining a KLT matrix based on the adaptive KLT matrix signal (at step 1602).

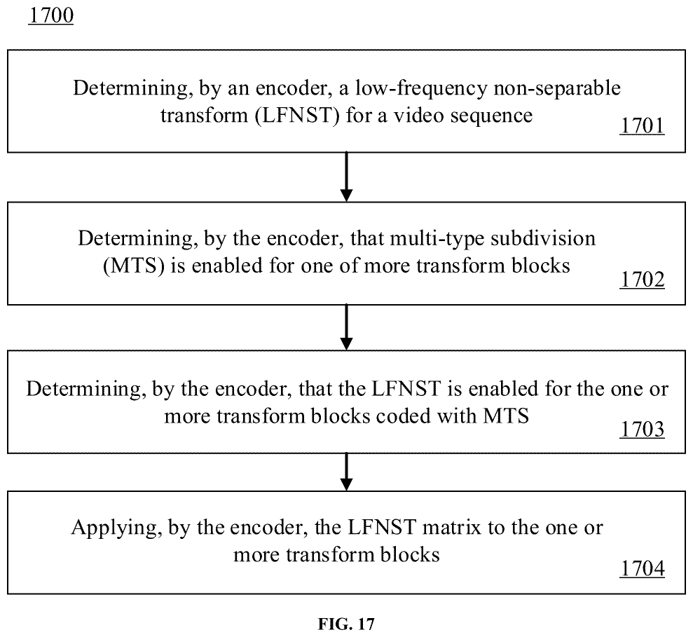

FIG. 17 is a flowchart illustrating a method 1700 for video encoding in accordance with some embodiments of the present disclosure. At step 1701, the method 1700 includes determining, by an encoder, a low-frequency non-separable transform (LFNST) for a video sequence. At step 1702, the method includes determining, by the encoder, that multiple transform selection (MTS) is enabled for one or more transform blocks. At step 1703, the method 1700 includes determining, by the encoder, that the LFNST is enabled for the one or more transform blocks coded with MTS. At step 1704, the method includes applying, by the encoder, the LFNST matrix to the one or more transform blocks.

In one example the method 1700 further includes training the LFNST matrix online or deriving the LFNST matrix offline. Training the LFNST matrix can include determining, by the encoder, a best transform matrix using rate-distortion optimization and updating, by the encoder, a transform set associated with the best LFNST matrix.

In one example, applying the LFNST matrix to the transform blocks can include generating, by the encoder, a set index for a transform set of the LFNST using a mapping strategy between an intra prediction mode and the transform set; and signaling, by the encoder, the intra prediction mode in a bitstream per intra coding unit.

In one example, the LFNST may include four distinct transform sets, wherein each distinct transform set includes two non-separable transform matrices.

In one example, a chroma block is coded with CCLM mode, and the method 1700 further includes generating, by the encoder, a CCLM mode flag to indicate using of one of the following CCLM modes: (i) INTRA_LT_CCLM; (ii) INTRA_L_CCLM; or (iii) INTRA_T_CCLM, signaling, by the encoder, the CCLM mode flag in the bit-stream and in response to determining the CCLM mode flag, selecting, by the encoder, the transform set 0 for the chroma block.

In one example, a luma block or chroma block is coded with non-CCLM mode, and the method 1700 further includes generating, by the encoder, an intra prediction mode represented by a value of IntraPredMode; signaling, by the encoder, the intra prediction mode in the bit-stream and in response to determining the IntraPredMode where IntraPredMode<0, selecting, by the encoder, the transform set 1 for the block and in response to determining the IntraPredMode where 0<=IntraPredMode<=1, selecting, by the encoder, the transform set 0 for the block and in response to determining the IntraPredMode where 2<=IntraPredMode<=12, selecting, by the encoder, the transform set 1 for the block and in response to determining the IntraPredMode where 13<=IntraPredMode<=23, selecting, by the encoder, the transform set 2 for the block and in response to determining the IntraPredMode where 24<=IntraPredMode<=44, selecting, by the encoder, the transform set 3 for the block and in response to determining the IntraPredMode where 45<=IntraPredMode<=55, selecting, by the encoder, the transform set 2 for the bloc and in response to determining the IntraPredMode where 56<=IntraPredMode<=80, selecting, by the encoder, the transform set 1 for the block.

In one example, a matrix index can be signaled to indicate the usage of a non-separable transform matrix in a LFNST transform set. The matrix index can be signaled in a bit-stream once per intra CU if all coefficients outside the first coefficient sub-group are non-significant.

In one example, for a first intra prediction mode, one transform set is used and one first non-separable transform matrix in the one transform set is used in the LFNST. In response to determining that the CU is coded using time based intra mode derivation (TIMD) mode, mapping the TIMD mode to a transform set with a set index: trIdx=(intraMode<2 intraMode: ((intraMode>>1)+1)).

In one example, in response to determining that a non-separable transform matrix is used for each transform set, signaling the matrix for the non-separable transform matrix. In some embodiments, the LFNST may be applied to intra CU in intra and inter slices for luma and chroma blocks. In response to determining that a dual tree is enabled, signaling respective set indices for luma and chroma components separately and in response to determining that a dual tree is not enabled, signaling a single set index for both luma and chroma components.

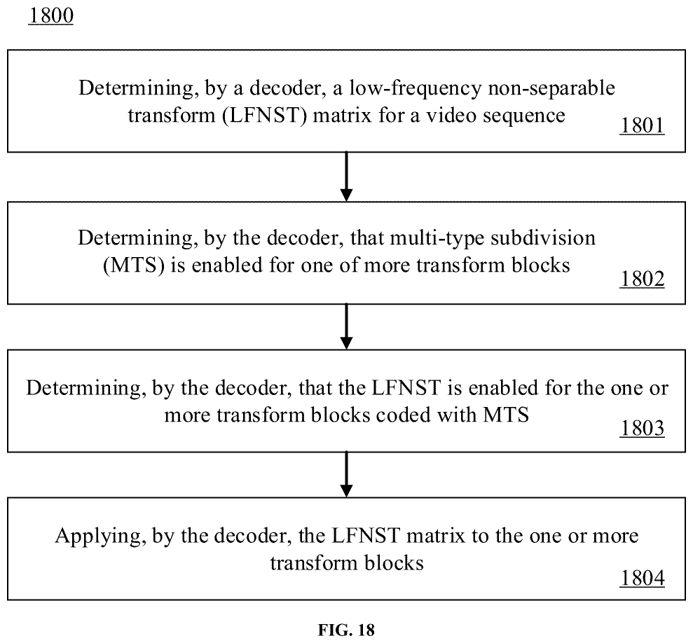

FIG. 18 is a flowchart illustrating a method 1800 for video decoding in accordance with some embodiments of the present disclosure. At step 1801, the method 1800 include determining, by a decoder, a low-frequency non-separable transform (LFNST) for a video sequence. At step 1802, the method 1800 includes determining, by the decoder, that multiple transform selection (MTS) is enabled for one or more transform blocks. At step 1803, the method 1800 includes determining, by the decoder, that the LFNST is enabled for the one or more transform blocks coded with MTS. At step 1804, the method 1800 includes applying, by the decoder, the LFNST matrix to the one or more transform blocks.

In one example, the method 1800 further comprises in response to determining that a dual tree is enabled, receiving respective set indices for luma and chroma components separately and in response to determining that a dual tree is not enabled, receiving a single set index for both luma and chroma components.

In one example, the method 1800 further comprises training the LFNST online or deriving the LFNST offline.

In one example, training the LFNST online further comprises determining, by the decoder, a best LFNST matrix using rate-distortion optimization and updating, by the decoder, a transform set associated with the best LFNST matrix.

In one example, the method 1800 further comprises generating, by the decoder, a set index for a transform set of the LFNST using a mapping strategy between an intra prediction mode and the transform set; and receiving, by the decoder, the intra prediction mode in the bitstream per intra coding unit. In some embodiments, the method 1200 further comprises receiving, by the decoder, a cross-component linear model (CCLM) flag for chroma blocks when a CCLM mode is applied to transform blocks with intra prediction mode, and receiving, by the decoder, the CCLM flag in a bit-stream once per intra coding unit (CU) to signal non-separable secondary transform candidates the intra prediction mode in the bitstream per intra coding unit.

In one example, the LFNST includes four distinct transform sets, wherein each distinct transform set includes two non-separable transform matrices.

In one example, a chroma block is coded with CCLM mode, and the method further comprises: receiving, by the decoder, a cross-component linear model (CCLM) mode flag from the bitstream to indicate use of one of the following CCLM modes: (i) INTRA_LT_CCLM; (ii) INTRA_L_CCLM; or (iii) INTRA_T_CCLM; in response to determining the CCLM mode flag, selecting, by the decoder, a transform set 0 for the chroma block using the mapping strategy.

In one example, a luma block or chroma block is coded with non-CCLM mode, and the method further includes receiving, by the decoder, an intra prediction mode represented by a value of IntraPredMode, receiving, by the decoder, the intra prediction mode in the bit-stream, in response to determining the IntraPredMode where IntraPredMode<0, selecting, by the decoder, the transform set 1 for the block, in response to determining the IntraPredMode where 0<=IntraPredMode<=1, selecting, by the decoder, the transform set 0 for the block, in response to determining the IntraPredMode where 2<=IntraPredMode<=12, selecting, by the decoder, the transform set 1 for the block, in response to determining the IntraPredMode where 13<=IntraPredMode<=23, selecting, by the decoder, the transform set 2 for the block, in response to determining the IntraPredMode where 24<=IntraPredMode<=44, selecting, by the decoder, the transform set 3 for the block, in response to determining the IntraPredMode where 45<=IntraPredMode<=55, selecting, by the decoder, the transform set 2 for the block and in response to determining the IntraPredMode where 56<=IntraPredMode<=80, selecting, by the decoder, the transform set 1 for the block.

In one example, applying the LFNST to transform blocks further includes applying, by the decoder, four distinct transform sets for intra prediction, wherein each distinct transform set includes two non-separable transform matrices.

In one example, the mapping strategy includes receiving, by the decoder, a CCLM mode flag to indicate use of one of the following CCLM modes: (i) Intra LT; (ii) Intra T; or (iii) Intra L, in response to determining the CCLM mode flag, selecting, by the decoder, the transform set 0 for the chroma block.

In one example, the method 1800 further includes signaling the matrix index to indicate the usage of the non-separable transform matrix in the transform set, wherein the first non-separable secondary transform matrix is signaled by a LFNST flag. The matrix index can be signaled in a bit-stream once per intra CU (e.g., if all coefficients outside the first coefficient sub-group are non-significant, then the matrix index can be signaled in the bit-stream). In one example, for a first intra prediction mode, one transform set and one first non-separable transform matrix is used in the LFNST.

In one example, in response to determining that the CU is coded using time based intra mode derivation (TIMD) mode, mapping the TIMD mode to a transform set with a set index:

$$trIdx = ( intraMode < 2 intraMode : ( ( intraMode >> 1 ) + 1 ) ) .$$

In one example, the method 1800 further includes in response to determining that a non-separable transform matrix is used for each transform set, receiving the matrix index for the non-separable transform matrix.

In one example, the LFNST is applied to intra CUs in intra and inter slices for luma and chroma blocks.

In one example, the method 1800 further includes in response to determining that a dual tree is enabled, receiving respective set indices for luma and chroma components separately and in response to determining that a dual tree is not enabled, receiving a single set index for both luma and chroma components.

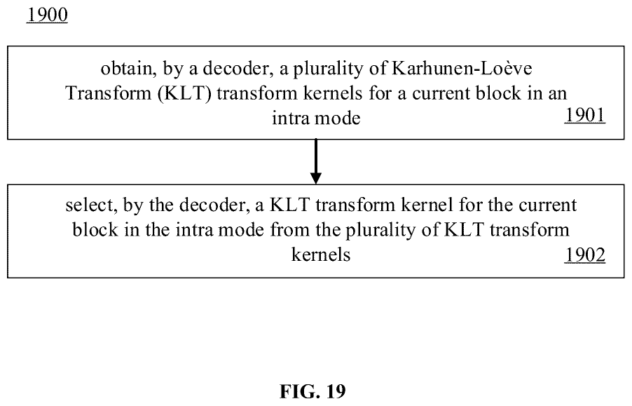

FIG. 19 is a flowchart illustrating a method 1900 for video decoding in accordance with some embodiments of the present disclosure. At step 1901, the method 1900 includes obtaining, by a decoder, a plurality of Karhunen-Loève Transform (KLT) transform kernels for a current block in an intra mode. At step 1902, the method includes selecting, by the decoder, a KLT transform kernel for the current block in the intra mode from the plurality of KLT transform kernels.

In some embodiments, the method 1900 further includes: receiving, by the decoder and from an encoder, a KLT flag that indicates whether KLT is enabled; and performing, by the decoder, one of following acts: in response to determining that the KLT flag is true, determining, by the decoder, that the KLT is enabled, and receiving, by the decoder and from the encoder, a KLT kernel index; or in response to determining that the KLT flag is false, determining, by the decoder, that the KLT is not enabled. In some embodiments, step 1902 includes: in response to determining that the KLT flag is true, selecting, by the decoder, the KLT transform kernel for the current block in the intra mode based on the KLT kernel index.

In some embodiments, the KLT kernel index is determined using a Rate-Distortion Optimization (RDO) technique.

In some embodiments, a number of the plurality of KLT transform kernels for each block size and intra mode is not limited. In some embodiments, the plurality of KLT transform kernels correspond to one or more first blocks of a first size and one or more second blocks of a second size, the first size is different from the second size, and a first number of the one or more first blocks is different from a second number of the one or more second blocks. Particularly, in some embodiments, the first size is 4×4, the first number is 3, the second size is 16×16, and the second number is 4.

In some embodiments, the KLT kernel index is a binarized value including one or more bins, and the one or more bins correspond to one or more contexts.

In some embodiments, the plurality of KLT transform kernels include a first KLT transform kernel and a second KLT transform kernel; the binarized value includes a first bin and a second bin; the one or more contexts include a first context and a second context; the first bin is context coded using the first context; and the second bin is context coded with the second context, or coded in a bypass mode. In some embodiments, being coded in a bypass mode means equal probability to indicate which KLT kernel is utilized.

In some embodiments, step 1902 includes one of following steps: in response to determining that the first bin is 0, determining that the KLT is not enabled; in response to determining that the first bin is 1 and the second bin is 0, selecting the first KLT transform kernel as the KLT transform kernel; or in response to determining that the first bin is 1 and the second bin is 1, selecting the second KLT transform kernel as the KLT transform kernel.

In some embodiments, the plurality of KLT transform kernels comprise a first KLT transform kernel, a second KLT transform kernel, and a third KLT transform kernel; the binarized value comprises a first bin, a second bin, and a third bin; the one or more contexts comprise a first context, a second context, and a third context; the first bin is context coded using the first context; the second bin is context coded using the second context; and the third bin is context coded with the third context, or coded in a bypass mode. In some embodiments, being coded in a bypass mode means equal probability to indicate which KLT kernel is utilized,

In some embodiments, step 1902 includes one of following steps: in response to determining that the first bin is 0, determining that the KLT is not enabled; in response to determining that the first bin is 1 and the second bin is 1, selecting the first KLT transform kernel as the KLT transform kernel; in response to determining that the first bin is 1, the second bin is 0, and the third bin is 0, selecting the second KLT transform kernel as the KLT transform kernel; or in response to determining that the first bin is 1, the second bin is 0, and the third bin is 1, selecting the third KLT transform kernel as the KLT transform kernel.

In some embodiments, the plurality of KLT transform kernels comprise a first KLT transform kernel, a second KLT transform kernel, a third KLT transform kernel, and a fourth KLT transform kernel; the binarized value comprises a first bin, a second bin, and a third bin; the one or more contexts comprise a first context, a second context, and a third context; the first bin is context coded using the first context; the second bin is context coded using the second context; and the third bin is context coded with the third context, or coded in a bypass mode. In some embodiments, being coded in a bypass mode means equal probability to indicate which KLT kernel is utilized.

In some embodiments, step 1902 includes one of following steps: in response to determining that the first bin is 0, determining that the KLT is not enabled; in response to determining that the first bin is 1, the second bin is 1, and the third bin is 1, selecting the first KLT transform kernel as the KLT transform kernel; in response to determining that the first bin is 1, the second bin is 1, and the third bin is 0, selecting the second KLT transform kernel as the KLT transform kernel; in response to determining that the first bin is 1, the second bin is 0, and the third bin is 0, selecting the third KLT transform kernel as the KLT transform kernel; or in response to determining that the first bin is 1, the second bin is 0, and the third bin is 1, selecting the fourth KLT transform kernel as the KLT transform kernel.

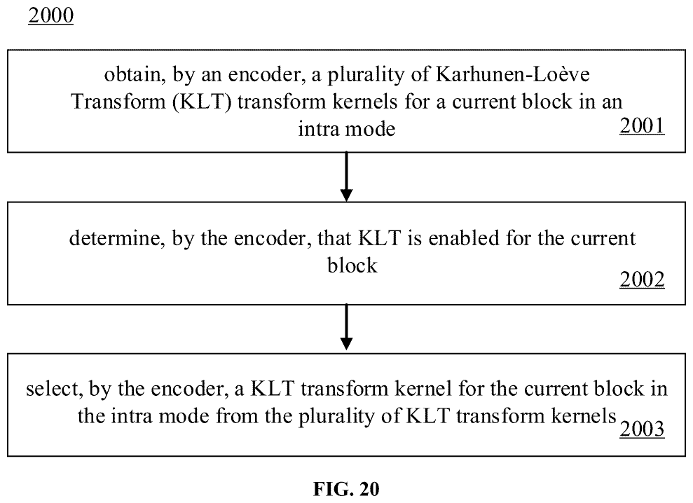

FIG. 20 is a flowchart illustrating a method 2000 for video encoding in accordance with some embodiments of the present disclosure and in correspondence with the method for video decoding illustrated in FIG. 19. At step 2001, the method 2000 includes obtaining, by an encoder, a plurality of Karhunen-Loève Transform (KLT) transform kernels for a current block in an intra mode. At step 2002, the method includes determining, by the encoder, that KLT is enabled for the current block. At step 2003, the method includes selecting, by the encoder, a KLT transform kernel for the current block in the intra mode from the plurality of KLT transform kernels.

In some embodiments, the method 2000 further includes: signaling, by the encoder and to a decoder, a KLT flag that indicates whether the KLT is enabled; and performing, by the encoder, one of following acts: in response to determining that the KLT is enabled, setting, by the encoder, the KLT flag as true, and signaling, by the encoder and to the decoder, a KLT kernel index; or in response to determining that the KLT is not enabled, setting, by the encoder, the KLT flag as false. In some embodiments, step 2003 includes: in response to determining that the KLT is enabled, selecting, by the encoder, the KLT transform kernel for the current block in the intra mode based on the KLT kernel index.

In some embodiments, the KLT kernel index is determined using a Rate-Distortion Optimization (RDO) technique. The RDO technique generally minimizes the amount of distortion (loss of video quality) against the amount of data required to encode the video, the rate.

In some embodiments, a number of the plurality of KLT transform kernels for each block size and intra mode is not limited. In some embodiments, the plurality of KLT transform kernels correspond to one or more first blocks of a first size and one or more second blocks of a second size, the first size is different from the second size, and a first number of the one or more first blocks is different from a second number of the one or more second blocks. Particularly, in some embodiments, the first size is 4×4, the first number is 3, the second size is 16×16, and the second number is 4.

In some embodiments, the KLT kernel index is a binarized value including one or more bins, and the one or more bins correspond to one or more contexts.

In some embodiments, the plurality of KLT transform kernels include a first KLT transform kernel and a second KLT transform kernel; the binarized value includes a first bin and a second bin; the one or more contexts include a first context and a second context; the first bin is context coded using the first context; and the second bin is context coded with the second context, or coded in a bypass mode. In some embodiments, being coded in a bypass mode means equal probability to indicate which KLT kernel is utilized.

In some embodiments, step 2003 includes one of following steps: in response to determining that the KLT is not enabled, setting the first bin as 0; in response to selecting the first KLT transform kernel as the KLT transform kernel, setting the first bin as 1 and the second bin as 0; or in response to selecting the second KLT transform kernel as the KLT transform kernel, setting the first bin as 1 and the second bin as 1.

In some embodiments, the plurality of KLT transform kernels comprise a first KLT transform kernel, a second KLT transform kernel, and a third KLT transform kernel; the binarized value comprises a first bin, a second bin, and a third bin; the one or more contexts comprise a first context, a second context, and a third context; the first bin is context coded using the first context; the second bin is context coded using the second context; and the third bin is context coded with the third context, or coded in a bypass mode. In some embodiments, being coded in a bypass mode means equal probability to indicate which KLT kernel is utilized.

In some embodiments, step 2003 includes one of following steps: in response to determining that the KLT is not enabled, setting the first bin as 0; in response to selecting the first KLT transform kernel as the KLT transform kernel, setting the first bin as 1 and the second bin as 1; in response to selecting the second KLT transform kernel as the KLT transform kernel, setting the first bin as 1, the second bin as 0, and the third bin as 0; or in response to selecting the third KLT transform kernel as the KLT transform kernel, setting the first bin as 1, the second bin as 0, and the third bin as 1.

In some embodiments, the plurality of KLT transform kernels comprise a first KLT transform kernel, a second KLT transform kernel, a third KLT transform kernel, and a fourth KLT transform kernel; the binarized value comprises a first bin, a second bin, and a third bin; the one or more contexts comprise a first context, a second context, and a third context; the first bin is context coded using the first context; the second bin is context coded using the second context; and the third bin is context coded with the third context, or coded in a bypass mode. In some embodiments, being coded in a bypass mode means equal probability to indicate which KLT kernel is utilized.

In some embodiments, step 2003 includes one of following steps: in response to determining that the KLT is not enabled, setting the first bin as 0; in response to selecting the first KLT transform kernel as the KLT transform kernel, setting the first bin as 1, the second bin as 1, and the third bin as 1; in response to selecting the second KLT transform kernel as the KLT transform kernel, setting the first bin as 1, the second bin as 1, and the third bin as 0; in response to selecting the third KLT transform kernel as the KLT transform kernel, setting the first bin as 1, the second bin as 0, and the third bin as 0; or in response to selecting the fourth KLT transform kernel as the KLT transform kernel, setting the first bin as 1, the second bin as 0, and the third bin as 1.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and embodiments be considered as exemplary only. The specification and embodiments are considered as exemplary. The application is intended to cover any variations, uses, or adaptations of the disclosure.

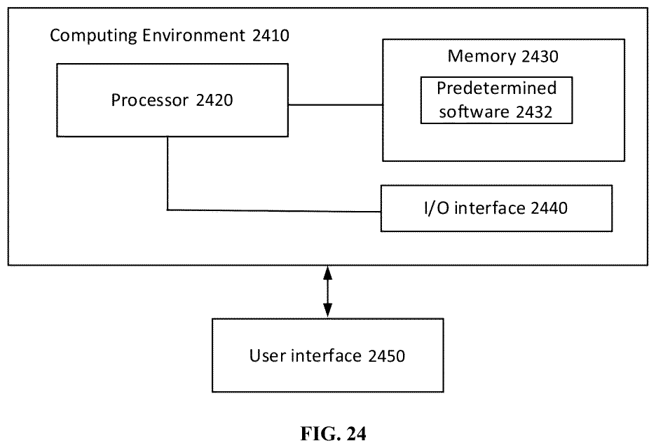

FIG. 24 shows a computing environment 2410 coupled with a user interface 2450. The computing environment 2410 can be part of a data processing server. The computing environment 2410 includes a processor 2420, a memory 2430, and an Input/Output (I/O) interface 2440.

The processor 2420 typically controls overall operations of the computing environment 2410, such as the operations associated with display, data acquisition, data communications, and image processing. The processor 2420 may include one or more processors to execute instructions to perform all or some of the steps in the above-described methods. Moreover, the processor 2420 may include one or more modules that facilitate the interaction between the processor 2420 and other components. The processor may be a Central Processing Unit (CPU), a microprocessor, a single chip machine, a Graphical Processing Unit (GPU), or the like.

The memory 2430 is configured to store various types of data to support the operation of the computing environment 2410. The memory 2430 may include predetermined software 2432. Embodiments of such data includes instructions for any applications or methods operated on the computing environment 2410, video datasets, image data, etc. The memory 2430 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

In one example, the memory 2430 is configured to store instructions executable by the processor; where the processor, upon execution of the instructions, is configured to perform any method as illustrated in FIGS. 11-20.

The I/O interface 2440 provides an interface between the processor 2420 and peripheral interface modules, such as a keyboard, a click wheel, buttons, and the like. The buttons may include but are not limited to, a home button, a start scan button, and a stop scan button. The I/O interface 2440 can be coupled with an encoder and decoder.

In an embodiment, there is also provided a non-transitory computer-readable storage medium comprising a plurality of programs, for example, in the memory 2430, executable by the processor 2420 in the computing environment 2410, for performing the above-described methods. Alternatively, the non-transitory computer-readable storage medium may have stored therein a bitstream or a data stream comprising encoded video information (for example, video information comprising one or more syntax elements) generated by an encoder (for example, the video encoder 20 in FIG. 2A) using, for example, the encoding method described above for use by a decoder (for example, the video decoder 30 in FIG. 3A) in decoding video data. The non-transitory computer-readable storage medium may be, for example, a ROM, a Random Access Memory (RAM), a CD-ROM, a magnetic tape, a floppy disc, an optical data storage device or the like.

In an embodiment, the is also provided a computing device comprising one or more processors (for example, the processor 2420); and the non-transitory computer-readable storage medium or the memory 2430 having stored therein a plurality of programs executable by the one or more processors, wherein the one or more processors, upon execution of the plurality of programs, are configured to perform the above-described methods.

In an embodiment, there is also provided a computer program product comprising a plurality of programs, for example, in the memory 2430, executable by the processor 2420 in the computing environment 2410, for performing the above-described methods. For example, the computer program product may include the non-transitory computer-readable storage medium.

In an embodiment, the computing environment 2410 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In some other embodiments, there is provided a non-transitory computer readable storage medium, having instructions stored therein. When the instructions are executed by a processor 2420, the instructions cause the processor to perform any method as illustrated in FIGS. 11-20. In one example, the plurality of programs may be executed by the processor 2420 in the computing environment 2410 to receive (for example, from the video encoder 20 in FIG. 2B) a bitstream or data stream including encoded video information (for example, video blocks representing encoded video frames, and/or associated one or more syntax elements, etc.), and may also be executed by the processor 2420 in the computing environment 2410 to perform the decoding method described above according to the received bitstream or data stream. In another example, the plurality of programs may be executed by the processor 2420 in the computing environment 2410 to perform the encoding method described above to encode video information (for example, video blocks representing video frames, and/or associated one or more syntax elements, etc.) into a bitstream or data stream, and may also be executed by the processor 2420 in the computing environment 2410 to transmit the bitstream or data stream (for example, to the video decoder 30 in FIG. 3A). Alternatively, the non-transitory computer-readable storage medium may have stored therein a bitstream or a data stream including encoded video information (for example, video blocks representing encoded video frames, and/or associated one or more syntax elements etc.) generated by an encoder (for example, the video encoder 20 in FIG. 2B) using, for example, the encoding method described above for use by a decoder (for example, the video decoder 30 in FIG. 3A) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 2430, executable by the processor 2420 in the computing environment 2410, for performing the above-described methods. For example, the computer program product may include the non-transitory computer-readable storage medium.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The embodiments were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific embodiments of the implementations disclosed and that modifications and other implementations are intended to be included within the scope of the present disclosure.

The above methods may be implemented using an apparatus that includes one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The apparatus may use the circuitries in combination with the other hardware or software components for performing the above described methods. Each module, sub-module, unit, or sub-unit disclosed above may be implemented at least partially using the one or more circuitries.

It will be appreciated that the present disclosure is not limited to the exact embodiments described above and illustrated in the accompanying drawings, and that various modifications and changes can be made without departing from the scope thereof.

In some aspects, there is provided a method for video encoding, comprising: deriving, by an encoder, a karhunen-loève transform (KLT) matrix from a video sequence; generating, by the encoder, an adaptive KLT matrix signal for the KLT matrix; and signaling, by the encoder, the adaptive KLT matrix signal in a sequence parameter set (SPS) header.

In some aspects, the method further comprises: applying, by the encoder, exponential-golomb (EG) codes to code elements within the KLT matrix.

In some aspects, the method further comprises: deriving, by the encoder, residues between the KLT matrix and a fixed KLT matrix; and signaling, by the encoder, the residues to a decoder.

In some aspects, the method further comprises: generating, by the encoder, a first flag to indicate that whetherMultiple Transform Selection (MTS) is enabled for a coding unit (CU); and generating, by the encoder, a second flag to indicate that whether KLT is enabled for the CU.

In some aspects, the method further comprises: in response to determining that the first flag indicates MTS is enabled and the second flag indicates KLT is not enabled, pairing, by the encoder, a matrix transform in versatile video coding (VVC) or enhanced compression mode (ECM) standards.

In some aspects, there is provided a method for video encoding, comprising: deriving, by an encoder, a karhunen-loève transform (KLT) matrix from each picture in a video sequence; generating, by the encoder, an adaptive KLT matrix signal for the KLT matrix; and signaling, by the encoder, the adaptive KLT matrix signal in a picture parameter set (PPS) header.

In some aspects, the method further comprises: applying, by the encoder, exponential-golomb (EG) codes to code elements within the KLT matrix.

In some aspects, the method further comprises: deriving, by the encoder, residues between the KLT matrix and a fixed KLT matrix; and signaling, by the encoder, the residues to a decoder.

In some aspects, the method further comprises: generating, by the encoder, a first flag to indicate that whether Multiple Transform Selection (MTS) is enabled for a coding unit (CU); and generating, by the encoder, a second flag to indicate that whether KLT is enabled for the CU.

In some aspects, the method further comprises: in response to determining that the first flag indicates MTS is enabled and the second flag indicates KLT is not enabled, pairing, by the encoder, a matrix transform in versatile video coding (VVC) or enhanced compression mode (ECM) standards.

In some aspects, there is provided a method for video encoding, comprising: deriving, by an encoder, a karhunen-loève transform (KLT) matrix from each slice in a video sequence; generating, by the encoder, an adaptive KLT matrix signal for the KLT matrix; and signaling, by the encoder, the adaptive KLT matrix signal in a slice header.

In some aspects, the method further comprises: applying, by the encoder, exponential-golomb (EG) codes to code elements within the KLT matrix.

In some aspects, the method further comprises: deriving, by the encoder, residues between the KLT matrix and a fixed KLT matrix; and signaling, by the encoder, the residues to a decoder

In some aspects, the method further comprises: generating, by the encoder, a first flag to indicate that whether Multiple Transform Selection (MTS) is enabled for a coding unit (CU); and generating, by the encoder, a second flag to indicate that whether KLT is enabled for the CU.

In some aspects, the method further comprises: in response to determining that the first flag indicates MTS is enabled and the second flag indicates KLT is not enabled, pairing, by the encoder, a matrix transform in versatile video coding (VVC) or enhanced compression mode (ECM) standards.

In some aspects, the method further comprises: in response to determining that the second flag indicates KLT is enabled, collecting, by the encoder, training data comprising quantization parameters (QPs); deriving, by the encoder, a KLT matrix based on the QPs; and selecting, by the encoder, a transform matrix that correspond to the derived KLT matrix.

In some aspects, there is provided a method for video decoding, comprising: receiving, by a decoder, an adaptive karhunen-loève transform (KLT) matrix signal in a sequence parameter set (SPS) header, wherein the adaptive KLT matrix signal is derived from a video sequence; and obtaining, by the decoder, a KLT matrix based on the adaptive KLT matrix signal.

In some aspects, the method further comprises: decoding, by the decoder, elements within the KLT matrix using exponential-golomb (EG) codes.

In some aspects, the method further comprises: predicting, by the decoder, the KLT matrix based on a fixed KLT matrix and decoded KLT matrix residual.

In some aspects, there is provided a method for video decoding, comprising: receiving, by a decoder, an adaptive karhunen-loève transform (KLT) matrix signal in a picture parameter set (PPS) header, wherein the adaptive KLT matrix signal is derived from a picture in a video sequence; and obtaining, by the decoder, a KLT matrix based on the adaptive KLT matrix signal.

In some aspects, the method further comprises: decoding, by the decoder, elements within the KLT matrix using exponential-golomb (EG) codes.

In some aspects, the method further comprises: predicting, by the decoder, the KLT matrix based on a fixed KLT matrix and decoded KLT matrix residual.

In some aspects, there is provided a method for video decoding, comprising: receiving, by a decoder, an adaptive karhunen-loève transform (KLT) matrix signal in a slice header, wherein the adaptive KLT matrix signal is derived from a slice in a video sequence; and obtaining, by the decoder, a KLT matrix based on the adaptive KLT matrix signal.

In some aspects, the method further comprises: decoding, by the decoder, elements within the KLT matrix using exponential-golomb (EG) codes.

In some aspects, the method further comprises: predicting, by the decoder, the KLT matrix based on a fixed KLT matrix and decoded KLT matrix residual.

In some aspects, there is provided a method for video encoding, comprising: determining, by an encoder, a low-frequency non-separable transform (LFNST) for a video sequence; determining, by the encoder, that multiple transform selection (MTS) is enabled for one or more transform blocks; determining, by the encoder, that the LFNST is enabled for the one or more transform blocks coded with the MTS; and applying, by the encoder, the LFNST to the one or more transform blocks.

In some aspects, determining the LFNST comprises: training the LFNST online; or deriving the LFNST offline.

In some aspects, training the LFNST online comprises: determining, by the encoder, a best LFNST matrix using rate-distortion optimization; and updating, by the encoder, a transform set associated with the best LFNST matrix.

In some aspects, the method further comprises: generating, by the encoder, a set index for a transform set of the LFNST using a mapping strategy between an intra prediction mode and the transform set; and signaling, by the encoder, the intra prediction mode in a bitstream per intra coding unit.

In some aspects, the LFNST comprises four distinct transform sets, wherein each distinct transform set comprises two non-separable transform matrices.

In some aspects, a chroma block is coded with CCLM mode, and the method further comprises: generating, by the encoder, a CCLM mode flag to indicate using of one of following CCLM modes: (i) INTRA_LT_CCLM; (ii) INTRA_L_CCLM; or (iii) INTRA_T_CCLM; wherein signaling, by the encoder, the intra prediction mode in a bitstream comprises: signaling, by the encoder, the CCLM mode flag in the bitstream; and wherein generating the index for the transform set using the mapping strategy comprises: selecting a transform set 0 for the chroma block based on the CCLM mode flag using the mapping strategy.

In some aspects, a luma block or chroma block is coded with non-CCLM mode, and the method further comprises: generating, by the encoder, an intra prediction mode represented by a value of IntraPredMode; wherein signaling, by the encoder, the intra prediction mode in a bitstream comprises: signaling, by the encoder, the intra prediction mode in the bit-stream; wherein generating the LFNST transform set using the mapping strategy comprises: in response to determining the IntraPredMode where IntraPredMode<0, selecting, by the encoder, the transform set 1 for the block using the mapping strategy; in response to determining the IntraPredMode where 0<=IntraPredMode<=1, selecting, by the encoder, the transform set 0 for the block using the mapping strategy; in response to determining the IntraPredMode where 2<=IntraPredMode<=12, selecting, by the encoder, the transform set 1 for the block using the mapping strategy; in response to determining the IntraPredMode where 13<=IntraPredMode<=23, selecting, by the encoder, the transform set 2 for the block using the mapping strategy; in response to determining the IntraPredMode where 24<=IntraPredMode<=44, selecting, by the encoder, the transform set 3 for the block using the mapping strategy; in response to determining the IntraPredMode where 45<=IntraPredMode<=55, selecting, by the encoder, the transform set 2 for the block using the mapping strategy; and in response to determining the IntraPredMode where 56<=IntraPredMode<=80, selecting, by the encoder, the transform set 1 for the block using the mapping strategy.

In some aspects, the method further comprises: signaling a matrix index to indicate usage of a non-separable transform matrix in a transform set.

In some aspects, for a first intra prediction mode, one first non-separable transform matrix in one transform set is used in the LFNST.

In some aspects, the method further comprises: in response to determining that a coding unit (CU) is coded using time based intra mode derivation (TIMD) mode, mapping the TIMD mode to a transform set with a set index.

In some aspects, the method further comprises: in response to determining that more than one LFNST matrices are used in one transform set, signaling a matrix index indicating a non-separable transform matrix in the one non-separable transform set.

In some aspects, the LFNST is applied to intra CUs in intra and inter slices for luma and chroma blocks.

In some aspects, the method further comprises: in response to determining that a dual tree is enabled, signaling respective set indices for luma and chroma components separately; and in response to determining that a dual tree is not enabled, signaling a single set index for both luma and chroma components.

In some aspects, there is provided a method for video decoding, comprising: determining, by a decoder, a low-frequency non-separable transform (LFNST) for a video sequence; determining, by the decoder, that multiple transform selection (MTS) is enabled for one or more transform blocks; determining, by the decoder, that the LFNST is enabled for the one or more transform blocks coded with MTS; and applying, by the decoder, the LFNST to the one or more transform blocks.

In some aspects, determining the LFNST comprises: training the LFNST online; or deriving the LFNST offline.

In some aspects, training the LFNST online comprises: determining, by the decoder, a best LFNST matrix using rate-distortion optimization; and updating, by the decoder, a transform set associated with the best LFNST matrix.

In some aspects, the method further comprises: generating, by the decoder, a set index for a transform set of the LFNST using a mapping strategy between an intra prediction mode and the transform set; and receiving, by the decoder, the intra prediction mode in the bitstream per intra coding unit.

In some aspects, the LFNST comprises four distinct transform sets, wherein each distinct transform set comprises two non-separable transform matrices.

In some aspects, a chroma block is coded with CCLM mode, and the method further comprises: receiving, by the decoder, a CCLM mode flag from the bitstream to indicate use of one of the following CCLM modes: (i) INTRA_LT_CCLM; (ii) INTRA_L_CCLM; or (iii) INTRA_T_CCLM; in response to determining the CCLM mode flag, selecting, by the decoder, a transform set 0 for the chroma block using the mapping strategy.

In some aspects, a luma block or chroma block is coded with non-CCLM mode, and the method further comprises: receiving, by the decoder, an intra prediction mode represented by a value of IntraPredMode; receiving, by the decoder, the intra prediction mode in the bit-stream; in response to determining the IntraPredMode where IntraPredMode<0, selecting, by the decoder, the transform set 1 for the block; in response to determining the IntraPredMode where 0<=IntraPredMode<=1, selecting, by the decoder, the transform set 0 for the block; in response to determining the IntraPredMode where 2<=IntraPredMode<=12, selecting, by the decoder, the transform set 1 for the block; in response to determining the IntraPredMode where 13<=IntraPredMode<=23, selecting, by the decoder, the transform set 2 for the block; in response to determining the IntraPredMode where 24<=IntraPredMode<=44, selecting, by the decoder, the transform set 3 for the block; in response to determining the IntraPredMode where 45<=IntraPredMode<=55, selecting, by the decoder, the transform set 2 for the block; and in response to determining the IntraPredMode where 56<=IntraPredMode<=80, selecting, by the decoder, the transform set 1 for the block.

In some aspects, the method further comprises: receiving a matrix index to indicate usage of a non-separable transform matrix in a LFNST transform set.

In some aspects, for a first intra prediction mode, one first non-separable transform matrix in one transform set is used in the LFNST.

In some aspects, the method further comprises: in response to determining that a coding unit (CU) is coded using time based intra mode derivation (TIMD) mode, mapping the TIMD mode to a transform set with a set index.

In some aspects, the method further comprises: in response to determining that a non-separable transform matrix is used for each transform set, receiving the matrix index for the non-separable transform matrix.

In some aspects, the LFNST is applied to intra CUs in intra and inter slices for luma and chroma blocks.

In some aspects, the method further comprises: in response to determining that a dual tree is enabled, receiving respective set indices for luma and chroma components separately; and in response to determining that a dual tree is not enabled, receiving a single set index for both luma and chroma components.

In some aspects, there is provided a method for video decoding, comprising: obtaining, by a decoder, a plurality of Karhunen-Loève Transform (KLT) transform kernels for a current block in an intra mode; and selecting, by the decoder, a KLT transform kernel for the current block in the intra mode from the plurality of KLT transform kernels.

In some aspects, the method further comprises: receiving, by the decoder and from an encoder, a KLT flag that indicates whether KLT is enabled; and performing, by the decoder, one of following acts: in response to determining that the KLT flag is true, determining, by the decoder, that the KLT is enabled, and receiving, by the decoder and from the encoder, a KLT kernel index; or in response to determining that the KLT flag is false, determining, by the decoder, that the KLT is not enabled.

In some aspects, selecting, by the decoder, the KLT transform kernel for the current block in the intra mode from the plurality of KLT transform kernels comprises: in response to determining that the KLT flag is true, selecting, by the decoder, the KLT transform kernel for the current block in the intra mode based on the KLT kernel index.

In some aspects, the plurality of KLT transform kernels correspond to one or more first blocks of a first size and one or more second blocks of a second size, the first size is different from the second size, and a first number of the one or more first blocks is different from a second number of the one or more second blocks.

In some aspects, the first size is 4×4, the first number is 3, the second size is 16× 16, and the second number is 4.

In some aspects, the KLT kernel index is a binarized value comprising one or more bins, and the one or more bins correspond to one or more contexts.

In some aspects, the plurality of KLT transform kernels comprise a first KLT transform kernel and a second KLT transform kernel; the binarized value comprises a first bin and a second bin; the one or more contexts comprise a first context and a second context; the first bin is context coded using the first context; and the second bin is coded with the second context, or coded in a bypass mode.

In some aspects, selecting, by the decoder, the KLT transform kernel for the current block in the intra mode from the plurality of KLT transform kernels comprises one of following steps: in response to determining that the first bin is 0, determining that the KLT is not enabled; in response to determining that the first bin is 1 and the second bin is 0, selecting the first KLT transform kernel as the KLT transform kernel; or in response to determining that the first bin is 1 and the second bin is 1, selecting the second KLT transform kernel as the KLT transform kernel.

In some aspects, the plurality of KLT transform kernels comprise a first KLT transform kernel, a second KLT transform kernel, and a third KLT transform kernel; the binarized value comprises a first bin, a second bin, and a third bin; the one or more contexts comprise a first context, a second context, and a third context; the first bin is context coded using the first context; the second bin is context coded using the second context; and the third bin is context coded with the third context, or coded with in a bypass mode.

In some aspects, selecting, by the decoder, the KLT transform kernel for the current block in the intra mode from the plurality of KLT transform kernels comprises one of following steps: in response to determining that the first bin is 0, determining that the KLT is not enabled; in response to determining that the first bin is 1 and the second bin is 1, selecting the first KLT transform kernel as the KLT transform kernel; in response to determining that the first bin is 1, the second bin is 0, and the third bin is 0, selecting the second KLT transform kernel as the KLT transform kernel; or in response to determining that the first bin is 1, the second bin is 0, and the third bin is 1, selecting the third KLT transform kernel as the KLT transform kernel.

In some aspects, the plurality of KLT transform kernels comprise a first KLT transform kernel, a second KLT transform kernel, a third KLT transform kernel, and a fourth KLT transform kernel; the binarized value comprises a first bin, a second bin, and a third bin; the one or more contexts comprise a first context, a second context, and a third context; the first bin is context coded using the first context; the second bin is context coded using the second context; and the third bin is context coded with the third context, or coded in a bypass mode.

In some aspects, selecting, by the decoder, the KLT transform kernel for the current block in the intra mode from the plurality of KLT transform kernels comprises one of following steps: in response to determining that the first bin is 0, determining that the KLT is not enabled; in response to determining that the first bin is 1, the second bin is 1, and the third bin is 1, selecting the first KLT transform kernel as the KLT transform kernel; in response to determining that the first bin is 1, the second bin is 1, and the third bin is 0, selecting the second KLT transform kernel as the KLT transform kernel; in response to determining that the first bin is 1, the second bin is 0, and the third bin is 0, selecting the third KLT transform kernel as the KLT transform kernel; or in response to determining that the first bin is 1, the second bin is 0, and the third bin is 1, selecting the fourth KLT transform kernel as the KLT transform kernel.

In some aspects, there is provided for a method for video encoding, comprising: obtaining, by an encoder, a plurality of Karhunen-Loève Transform (KLT) transform kernels for a current block in an intra mode; determining, by the encoder, that KLT is enabled for the current block; and selecting, by the encoder, a KLT transform kernel for the current block in the intra mode from the plurality of KLT transform kernels.

In some aspects, the method further comprises: signaling, by the encoder and to a decoder, a KLT flag that indicates whether the KLT is enabled; and performing, by the encoder, one of following acts: in response to determining that the KLT is enabled, setting, by the encoder, the KLT flag as true, and signaling, by the encoder and to the decoder, a KLT kernel index; or in response to determining that the KLT is not enabled, setting, by the encoder, the KLT flag as false.

In some aspects, selecting, by the encoder, the KLT transform kernel for the current block in the intra mode from the plurality of KLT transform kernels comprises: in response to determining that the KLT is enabled, selecting, by the encoder, the KLT transform kernel for the current block in the intra mode based on the KLT kernel index.

In some aspects, the plurality of KLT transform kernels correspond to one or more first blocks of a first size and one or more second blocks of a second size, the first size is different from the second size, and a first number of the one or more first blocks is different from a second number of the one or more second blocks.

In some aspects, the first size is 4×4, the first number is 3, the second size is 16×16, and the second number is 4.

In some aspects, the KLT kernel index is a binarized value comprising one or more bins, and the one or more bins correspond to one or more contexts.

In some aspects, the plurality of KLT transform kernels comprise a first KLT transform kernel and a second KLT transform kernel; the binarized value comprises a first bin and a second bin; the one or more contexts comprise a first context and a second context; the first bin is context coded using the first context; and the second bin is context coded with the second context, or coded in a bypass mode.

In some aspects, selecting, by the encoder, the KLT transform kernel for the current block in the intra mode from the plurality of KLT transform kernels comprises one of following steps: in response to determining that the KLT is not enabled, setting the first bin as 0; in response to selecting the first KLT transform kernel as the KLT transform kernel, setting the first bin as 1 and the second bin as 0; or in response to selecting the second KLT transform kernel as the KLT transform kernel, setting the first bin as 1 and the second bin as 1.

In some aspects, the plurality of KLT transform kernels comprise a first KLT transform kernel, a second KLT transform kernel, and a third KLT transform kernel; the binarized value comprises a first bin, a second bin, and a third bin; the one or more contexts comprise a first context, a second context, and a third context; the first bin is context coded using the first context; the second bin is context coded using the second context; and the third bin is context coded with the third context, or coded in a bypass mode.

In some aspects, selecting, by the encoder, the KLT transform kernel for the current block in the intra mode from the plurality of KLT transform kernels comprises one of following steps: in response to determining that the KLT is not enabled, setting the first bin as 0; in response to selecting the first KLT transform kernel as the KLT transform kernel, setting the first bin as 1 and the second bin as 1; in response to selecting the second KLT transform kernel as the KLT transform kernel, setting the first bin as 1, the second bin as 0, and the third bin as 0; or in response to selecting the third KLT transform kernel as the KLT transform kernel, setting the first bin as 1, the second bin as 0, and the third bin as 1.

In some aspects, the plurality of KLT transform kernels comprise a first KLT transform kernel, a second KLT transform kernel, a third KLT transform kernel, and a fourth KLT transform kernel; the binarized value comprises a first bin, a second bin, and a third bin; the one or more contexts comprise a first context, a second context, and a third context; the first bin is context coded using the first context; the second bin is context coded using the second context; and the third bin is context coded with the third context, or coded in a bypass mode.

In some aspects, selecting, by the encoder, the KLT transform kernel for the current block in the intra mode from the plurality of KLT transform kernels comprises one of following steps: in response to determining that the KLT is not enabled, setting the first bin as 0; in response to selecting the first KLT transform kernel as the KLT transform kernel, setting the first bin as 1, the second bin as 1, and the third bin as 1; in response to selecting the second KLT transform kernel as the KLT transform kernel, setting the first bin as 1, the second bin as 1, and the third bin as 0; in response to selecting the third KLT transform kernel as the KLT transform kernel, setting the first bin as 1, the second bin as 0, and the third bin as 0; or in response to selecting the fourth KLT transform kernel as the KLT transform kernel, setting the first bin as 1, the second bin as 0, and the third bin as 1.

What is claimed is:

1. A method for video encoding, comprising:
deriving, by an encoder, a karhunen-loève transform (KLT) matrix from a video sequence, each picture in the video sequence, or each slice in the video sequence;
generating, by the encoder, an adaptive KLT matrix signal for the KLT matrix; and
signaling, by the encoder, the adaptive KLT matrix signal in a sequence parameter set (SPS) header in response to the KLT matrix being derived from the video sequence, in a picture parameter set (PPS) header in response to the KLT matrix being derived from each picture in the video sequence, or in a slice header in response to the KLT matrix being derived from each slice in the video sequence.

2. The method for video encoding of claim 1, further comprising:
applying, by the encoder, exponential-golomb (EG) codes to code elements within the KLT matrix.

3. The method for video encoding of claim 1, further comprising:
deriving, by the encoder, residues between the KLT matrix and a fixed KLT matrix; and
signaling, by the encoder, the residues to a decoder.

4. The method for video encoding of claim 1, further comprising:
generating, by the encoder, a first flag to indicate whether Multiple Transform Selection (MTS) is enabled for a coding unit (CU); and
generating, by the encoder, a second flag to indicate whether KLT is enabled for the CU.

5. The method for video encoding of claim 4, further comprising:
in response to determining that the first flag indicates MTS being enabled and the second flag indicates KLT being not enabled, pairing, by the encoder, a matrix transform in versatile video coding (VVC) or enhanced compression mode (ECM) standards.

6. The method for video encoding of claim 5, further comprising:
in response to determining that the second flag indicates KLT being enabled, collecting, by the encoder, training data comprising quantization parameters (QPs);
deriving, by the encoder, the KLT matrix based on the QPs; and
selecting, by the encoder, a transform matrix that correspond to the derived KLT matrix.

7. A method for video decoding, comprising:
receiving, by a decoder, an adaptive karhunen-loève transform (KLT) matrix signal in a sequence parameter set (SPS) header in response to the adaptive KLT matrix signal being derived from a video sequence, in a picture parameter set (PPS) header in response to the adaptive KLT matrix signal being derived from each picture in the video sequence, or in a slice header in response to the adaptive KLT matrix signal being derived from each slice in the video sequence; and
obtaining, by the decoder, a KLT matrix based on the adaptive KLT matrix signal.

8. The method for video decoding of claim 7, further comprising:
decoding, by the decoder, elements within the KLT matrix using exponential-golomb (EG) codes.

9. The method for video decoding of claim 7, further comprising:
predicting, by the decoder, the KLT matrix based on a fixed KLT matrix and decoded KLT matrix residual.

10. An apparatus for video coding, comprising:
one or more processors; and
a memory coupled to the one or more processors and configured to store instructions executable by the one or more processors, wherein the one or more processors, upon execution of the instructions are configured to perform operations comprising:
deriving, by an encoder, a karhunen-loève transform (KLT) matrix from a video sequence, each picture in the video sequence, or each slice in the video sequence;
generating, by the encoder, an adaptive KLT matrix signal for the KLT matrix; and
signaling, by the encoder, the adaptive KLT matrix signal in a sequence parameter set (SPS) header in response to the KLT matrix being derived from the video sequence, in a picture parameter set (PPS) header in response to the KLT matrix being derived from each picture in the video sequence, or in a slice header in response to the KLT matrix being derived from each slice in the video sequence; or
to perform operations comprising:
receiving, by a decoder, the adaptive KLT matrix signal in the SPS header in response to the adaptive KLT matrix signal being derived from a video sequence, in the PPS header in response to the adaptive KLT matrix signal being derived from each picture in the video sequence, or in a slice header in response to the adaptive KLT matrix signal being derived from each slice in the video sequence; and
obtaining, by the decoder, the KLT matrix based on the adaptive KLT matrix signal.

11. The apparatus for video coding of claim 10, wherein the one or more processors, upon execution of the instructions are configured to further perform operations comprising:
applying, by the encoder, exponential-golomb (EG) codes to code elements within the KLT matrix.

12. The apparatus for video coding of claim 10, wherein the one or more processors, upon execution of the instructions are configured to further perform operations comprising:
deriving, by the encoder, residues between the KLT matrix and a fixed KLT matrix; and
signaling, by the encoder, the residues to a decoder.

13. The apparatus for video coding of claim 10, wherein the one or more processors, upon execution of the instructions are configured to further perform operations comprising:
generating, by the encoder, a first flag to indicate whether Multiple Transform Selection (MTS) is enabled for a coding unit (CU); and
generating, by the encoder, a second flag to indicate whether KLT is enabled for the CU.

14. The apparatus for video coding of claim 13, wherein the one or more processors, upon execution of the instructions are configured to further perform operations comprising:
in response to determining that the first flag indicates MTS being enabled and the second flag indicates KLT being not enabled, pairing, by the encoder, a matrix transform in versatile video coding (VVC) or enhanced compression mode (ECM) standards.

15. The apparatus for video coding of claim 14, wherein the one or more processors, upon execution of the instructions are configured to further perform operations comprising:
in response to determining that the second flag indicates KLT being enabled, collecting, by the encoder, training data comprising quantization parameters (QPs);
deriving, by the encoder, the KLT matrix based on the QPs; and
selecting, by the encoder, a transform matrix that correspond to the derived KLT matrix.

16. The apparatus for video coding of claim 10, wherein the one or more processors, upon execution of the instructions are configured to further perform operations comprising:
decoding, by the decoder, elements within the KLT matrix using exponential-golomb (EG) codes.

17. The apparatus for video coding of claim 10, wherein the one or more processors, upon execution of the instructions are configured to further perform operations comprising:
predicting, by the decoder, the KLT matrix based on a fixed KLT matrix and decoded KLT matrix residual.

18. A non-transitory computer readable storage medium for storing a bitstream generated by the method of claim 1.

19. A non-transitory computer readable storage medium for storing a bitstream to be decoded by the method of claim 7.
